(19) United States
(12) Patent Application Publication
(10) Pub. No.: US 2001/0031714 A1
(43) Pub. Date: Oct. 18, 2001

(54) Laundry, dishwashing or cleaning product detergent portions with controlled release of active substance

(76) Inventors: Thomas Gassenmeier, Duesseldorf (DE); Christian Nitsch, Duesseldorf (DE); Wolfgang Von Rybinski, Duesseldorf (DE); Peter Schmiedel, Duesseldorf (DE); Stefan Evers, Mettmann (DE); Michael Dreja, Koeln (DE); Rolf Bayersdoerfer, Landau (DE); Maren Jekel, Duesseldorf (DE); Ute Krupp, Essen (DE); Albrecht Weiss, Langenfeld (DE)

Correspondence Address: Glenn E.J. Murphy, Henkel Corporation, Patent Law Dept., Suite 200, 2500 Renaissance Blvd., Gulph Mills, PA, 19406, US

(21) Appl. No.: 09/735,423

(22) Filed: Dec. 13, 2000

(30) Foreign Application Priority Data
Dec. 13, 1999 (DE) 199 60 072.4
Jul. 22, 2000 (DE) 100 35 781.4

(51) Int. Cl. C11D 3/37

(52) U.S. Cl. 510/276

(57) ABSTRACT

The invention relates to a laundry, dishwashing or cleaning product detergent portion having two or more detersive components of which at least two are to be released into the liquor at different points in time in a laundering, dishwashing or cleaning process, said portion comprising at least one release controlling (physico)chemical switch which is not subject or not exclusively subject to temperature control, and also one or more substances for increasing the extent of the shift in pH.

The present invention relates to laundry, dishwashing or cleaning product detergent portions with controlled release of active substance. In particular, the present invention relates to laundry, dishwashing or cleaning product detergent portions possessing a system permitting controlled release of at least one active substance in the laundering, dishwashing, cleaning, or aftertreatment process. The invention also relates to a process for producing such laundry, dishwashing or cleaning product detergent portions. The invention also relates to laundering, dishwashing or cleaning processes using said laundry, dishwashing or cleaning product detergent portions.

For a long time it was the norm to provide the consumer with laundry detergents, dishwashing detergents or cleaning product detergents in the form of bulk-packaged goods and to leave it up to the consumer at the time of use to dose the laundry detergent, dishwashing detergent or cleaning product detergent in accordance with the requirements of the application, which depended on the water hardness, the nature, amount, and/or degree of soiling of the laundry, ware or article to be cleaned, on the amount of the washing or cleaning liquor, and on other parameters.

In view of the consumer's desire to have laundry, dishwashing or cleaning product detergents which are easier and more convenient to dose, these detergents were increasingly provided in a form which obviates the need for ad hoc dosing: laundry detergents, dishwashing detergents or cleaning product detergents were formulated in predetermined portions comprising all of the components required for one washing or cleaning cycle or operation. In the case of solid products, such portions were frequently formed into shapes (sometimes comprising two or more phases) such as granules, beads, tablets (“tabs”), cubes, briquettes, etc., which are dosed as a whole into the liquor. Liquid products were placed in water-soluble enclosures which dissolve on contact with the aqueous liquor and release the contents into the liquor.

A disadvantage of these solutions is that all of the components required in the course of a wash or cleaning cycle or operation pass simultaneously into the aqueous liquor. In this case, not only are there problems of incompatibility of certain components of a laundry detergent, dishwashing detergent or cleaning product detergent with other components, but also it becomes impossible deliberately to dose certain components into the liquor at a defined point in time.

The prior art has since described means by which individual laundry detergent, dishwashing detergent or cleaning product detergent components may be dosed deliberately and at a defined point in time during use. For example, the temperature controlled release of active substances is described, permitting active substances such as surfactants, bleaches, soil release polymers and the like to be released either in the main wash or cleaning cycle or operation or even in an aftertreatment cycle or operation—for example, in the rinse cycle in the case of machine dishwashing.

There have been a plurality of descriptions of the use of paraffins having a melting point of more than 50° C. One product on the market, in a dishwashing detergent tablet, makes use of a paraffin core as carrier or matrix in order to cause a rinse aid surfactant incorporated therein to be released not in the wash cycle but only in the rinse cycle of a dishwasher. In the case of premature release, such as during the wash cycle, for example, the rinse aid surfactant is to a very great extent pumped away during intermediate washing, and is then able to develop little if any of its activity in the rinse cycle. If the matrix material has a melting point at the temperature of the rinse cycle, this ensures that the rinse aid surfactant—which is emulsified or, ideally, distributed in molecularly disperse form in the matrix—remains enclosed in the matrix during the wash cycle, which takes place at temperatures up to 55° C., and is released only in the rinse cycle, in which temperatures of up to about 65° C. are attained, following melting of the matrix material.

This solution to protect the rinse aid surfactant has become established in practice. However, a disadvantage is that the proportion of the matrix material in the core, consisting of paraffin and rinse aid surfactant, of the dishwashing detergent tablet accounts for between 30 and 95% of the overall mass of the core, generally about 50% of the overall mass. The matrix material, especially in this amount, may leave residues on the articles to be cleaned, such as on the kitchen- and tableware, for example, and may also impair the activity of the rinse aid surfactant it contains, which is released when the paraffin melts. One reason for this might be that after the paraffin has melted, the rinse aid surfactant remains bound at the interface between lipophilic carrier material and the wash liquor and so does not develop the desired action.

A further disadvantage of the temperature controlled release of active substances in detergents is that, in the washing machines and dishwashers that are typically used within households there is a relatively large number of programs, which differ significantly in temperature and time, in particular. For example, the programs nowadays used most frequently in dishwashers have peak temperatures in the wash cycle of from 50 to 60° C. or from 60 to 70° C., the exact level of the temperature possibly being different depending on manufacturer and machine type. However effective the functioning of a temperature controlled active substance release per se, the effect achieved is frequently still dependent on the type of machine used and on consumer behavior.

As one approach, this fact can be dealt with by means of systems which, rather than a certain maximum achievable temperature, which is subject to the breadth of range described above, react to the control parameter of cooling and use it for the targeted release of active substances from laundry detergent, dishwashing detergent or cleaning product detergent portions. For instance, one of the applicant's earlier German patent applications, unpublished at the priority date of the present specification, describes laundry detergents, dishwashing detergents or cleaning product detergents comprising polymers which are called LCST polymers and possess the particular property that they are insoluble above a certain temperature (flocculation point) and dissolve only at lower temperatures. This principle may be used for all applications where release of certain components is to take place during the cooling phase in the laundering, dishwashing or cleaning process after the temperature has gone below the flocculation point of the LCST polymers. Applications which meet these criteria are, for example, machine dishwashing and machine laundering, provided the wash liquor is pumped off in intermediate wash cycles and replaced by cold or relatively cold washing or rinsing water.

Another principle which has been described is based on the fact that when a volume of air heated to a certain temperature is cooled there is a volume decrease by approximately 1/272 per ° Kelvin. By means of an appropriate embodiment, such as a perforated capsule, for example, material may be drawn from the immediate environment into the embodiment as a result of the underpressure resulting from the air volume contraction. This step may then trigger secondary processes such as corrosion, dissolution, heating or gas formation, which allow release of the desired ingredients.

Disadvantages of said controlled active substance release by means of a temperature switch lie in the dependency they exhibit on certain temperature programs and/or on the need for cooling during the laundering, dishwashing or cleaning process.

It is an object of the invention, then, to provide switch systems which do not have the aforementioned disadvantages.

It was also an object of the invention to provide a system for the controlled release of laundry, dishwashing or cleaning product detergent components into the liquor, from a laundry, dishwashing or cleaning product detergent portion which ensures that the relevant component passes into the liquor at a defined point in time with, as far as possible, a minimal amount if any of auxiliaries needed for compounding.

A further object of the invention was to provide a system for separating individual components of a laundry, dishwashing or cleaning product detergent from other components of the same detergent for the purpose of avoiding incompatibilities of the individual components during production, storage and/or transit and thus to ensure that the components pass into the washing or cleaning liquor without loss of activity at a defined point in time, together if desired with other, precisely defined components.

A further object of the invention was to provide the possibility of supplying not only naturally solid components of a laundry detergent, dishwashing detergent or cleaning product detergent for a utility but also those components which are in a nonsolid form, for example, in liquid, gel or paste form, or for a utility with such components in a different aggregate state.

The invention accordingly provides a laundry, dishwashing or cleaning product detergent portion having two or more detersive components of which at least two are to be released into the liquor at different points in time in a laundering, dishwashing or cleaning process, said portion comprising at least one release controlling (physico)chemical switch which is not subject or not exclusively subject to temperature control, and also one or more substances for increasing the extent of the shift in pH.

In one preferred embodiment the invention provides a laundry, dishwashing or cleaning product detergent portion of the stated type wherein the (physico)chemical switch(es) controlling the release of at least one detersive component is(are) one or more components, when there is a change in the electrolyte concentration in the wash or cleaning liquor, undergo a change in physical and/or chemical properties.

Further preference is given in accordance with the invention to a laundry, dishwashing or cleaning product detergent portion wherein the (physico)chemical switch(es) controlling the release of at least one detersive component is(are) one or more components, when there is a change in the H⁺ ion concentration (the pH) in the wash or cleaning liquor, undergo a change in physical and/or chemical properties.

The invention further provides a process for producing a laundry, dishwashing or cleaning product detergent portion having two or more detersive components of which at least two are to be released into the liquor at different points in time in a washing or cleaning process, which comprises compounding the detersive component(s) for release into the liquor at a later point in time in the washing or cleaning process with a release controlling (physico)chemical switch and processing the detersive component(s) thus compounded with one or more other detersive components to give a laundry, dishwashing or cleaning product detergent portion.

The invention additionally provides a laundering, dishwashing or cleaning process using the laundry, dishwashing or cleaning product detergent portions which are described in detail below.

The invention primarily provides laundry detergent portions, dishwashing detergent portions or cleaning product detergent portions. In the context of the present invention, the term “laundry detergent portion” or “dishwashing detergent portion” or “cleaning product detergent portion” refers to an amount of a laundry, dishwashing or cleaning product detergent that is sufficient for one washing or cleaning procedure which takes place in an aqueous phase. This may be, for example, a machine washing or cleaning procedure, as carried out with standard commercial washing machines or dishwashers. In accordance with the invention, however, this term also embraces a handwash laundry operation or manual dishwashing operation (carried out, for example, in a wash basin or in a bowl) or some other laundering, dishwashing or cleaning procedure. In accordance with the invention, the laundry, dishwashing or cleaning product detergent portions are used in machine laundering, dishwashing or cleaning procedures.

In the context of the present invention, the term “laundry detergent subportion”, “dishwashing detergent subportion” or “cleaning product detergent subportion” refers to a component amount of a laundry detergent portion, dishwashing detergent portion or cleaning product detergent portion which is present in a phase separate from other laundry, dishwashing or cleaning product detergent subportions, in spatial communication with other laundry, dishwashing or cleaning product detergent subportions of the same laundry, dishwashing or cleaning product detergent portion and which by means of appropriate measures has been formulated or compounded in such a way that it may be placed into the liquor and, if desired, dissolved or suspended in it separately from other laundry, dishwashing or cleaning product detergent subportions of the same laundry, dishwashing or cleaning product detergent portion. One laundry, dishwashing or cleaning product detergent subportion may comprise the same ingredients as another laundry, dishwashing or cleaning product detergent subportion of the same laundry, dishwashing or cleaning product detergent portion; preferably, however, two laundry, dishwashing or cleaning product detergent subportions of the same laundry, dishwashing or cleaning product detergent portion comprise different ingredients, in particular different detersive formulations.

In accordance with the invention, the laundry, dishwashing or cleaning product detergent portions comprise measured amounts of at least one detersive formulation, usually measured amounts of two or more detersive formulations. It is possible for the portions to comprise only detersive formulations of one particular make-up. In accordance with the invention it is preferred, however, for two or more, usually at least two, detersive formulations of different make-up to be present in the laundry, dishwashing or cleaning product detergent portions. The make-up may be different in terms of the concentration of the individual components of the detersive formulation (quantitatively) and/or in terms of the nature of the individual components of the detersive formulation (qualitatively). It is particularly preferred for the components to be adapted in terms of nature and concentration to the tasks which the laundry, dishwashing or cleaning product detergent subportions are required to fulfill in the laundering, dishwashing or cleaning procedure.

In the context of the present invention, the term “detersive formulation/component” embraces formulations or components of all conceivable substances that are relevant in the context of a laundering, dishwashing or cleaning procedure. These substances are, primarily, the laundry detergents, dishwashing detergents or cleaning product detergents themselves, with their individual components which are elucidated further in the ongoing course of the description. These include active substances such as surfactants (anionic, nonionic, cationic and amphoteric surfactants), builder substances (organic and inorganic builder substances), bleaches (such as peroxo bleaches and chlorine bleaches, for example), bleach activators, bleach stabilizers, bleaching catalysts, enzymes, special polymers (for example, those having cobuilder properties), graying inhibitors, dyes and fragrances (perfumes), without the term being restricted to these groups of substances.

The term “detersive formulation/component” also, however, embraces laundering assistants, dishwashing assistants and cleaning assistants. Examples of these assistants are optical brighteners, UV protection substances, soil repellants, i.e., polymers which counter redirtying of fibers or hard surfaces, and silver protectants. In accordance with the invention, laundry treatment compositions such as fabric softeners, and dishwashing composition additions such as rinse aids, are also regarded as detersive formulations or components.

The laundry, dishwashing or cleaning product detergent portions of the invention comprise one or more substances from the group consisting of surfactants, compounded surfactants, builders, bleaches, bleach activators, enzymes, foam inhibitors, dyes and fragrances and also—where the laundry, dishwashing or cleaning product detergent portions are present at least in part as shaped bodies—binders and disintegration aids as well. These classes of substance are described below.

To develop the wash performance, the laundry, dishwashing and cleaning product detergent portions of the invention may comprise surface-active substances from the group consisting of anionic, nonionic, zwitterionic and cationic surfactants, distinct preference being given to anionic surfactants on economic grounds and because of their performance spectrum.

Anionic surfactants used are, for example, those of the sulfonate and sulfate type. Preferred surfactants of the sulfonate type are C₉₋₁₃ alkylbenzenesulfonates, olefinsulfonates, i.e., mixtures of alkenesulfonates and hydroxyalkanesulfonates, and also disulfonates, as are obtained, for example, from C₁₂₋₁₈ monoolefins having a terminal or internal double bond by sulfonating with gaseous sulfur trioxide followed by alkaline or acidic hydrolysis of the sulfonation products. Also suitable are alkanesulfonates, which are obtained from C₁₂₋₁₈ alkanes, for example, by sulfochlorination or sulfoxidation with subsequent hydrolysis or neutralization, respectively. Likewise suitable, in addition, are the esters of 2-sulfo fatty acids (ester sulfonates), e.g., the 2-sulfonated methyl esters of hydrogenated coconut, palm kernel or tallow fatty acids.

Further suitable anionic surfactants are sulfated fatty acid glycerol esters. Fatty acid glycerol esters are the monoesters, diesters and triesters, and mixtures thereof, as obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having 6 to 22 carbon atoms, examples being those of caproic acid, caprylic acid, capric acid, myristic acid, lauric acid, palmitic acid, stearic acid, or behenic acid.

Preferred alk(en)yl sulfates are the alkali metal salts, and especially the sodium salts, of the sulfuric monoesters of C₁₂-C₁₈ fatty alcohols, examples being those of coconut fatty alcohol, tallow fatty alcohol, lauryl, myristyl, cetyl or stearyl alcohol, or of C₁₀-C₂₀ oxo alcohols, and those monoesters of secondary alcohols of these chain lengths. Preference is also given to alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a detergents standpoint, the C₁₂-C₁₆ alkyl sulfates and C₁₂-C₁₅ alkyl sulfates, and also C₁₄-C₁₅ alkyl sulfates, are preferred. In addition, 2,3-alkyl sulfates, which may for example be prepared in accordance with U.S. Pat. Nos. 3,234,258 or 5,075,041 and obtained as commercial products from Shell Oil Company under the name DAN®, are suitable anionic surfactants.

Also suitable are the sulfuric monoesters of the straight-chain or branched C₇₋₂₁ alcohols ethoxylated with from 1 to 6 mol of ethylene oxide, such as 2-methyl-branched C₉₋₁₁ alcohols containing on average 3.5 mol of ethylene oxide (EO) or C₁₂₋₁₈ fatty alcohols containing from 1 to 4 EO. Because of their high foaming behavior they are used in detergents only in relatively small amounts, for example, in amounts of from 1 to 5% by weight.

Further suitable anionic surfactants include the salts of alkylsulfosuccinic acid, which are also referred to as sulfosuccinates or as sulfosuccinic esters and which constitute monoesters and/or diesters of sulfosuccinic acid with alcohols, preferably fatty alcohols and especially ethoxylated fatty alcohols. Preferred sulfosuccinates comprise C₈₋₁₈ fatty alcohol radicals or mixtures thereof. Especially preferred sulfosuccinates contain a fatty alcohol radical derived from ethoxylated fatty alcohols which themselves represent nonionic surfactants (for description, see below). Particular preference is given in turn to sulfosuccinates whose fatty alcohol radicals are derived from ethoxylated fatty alcohols having a narrowed homolog distribution. Similarly, it is also possible to use alk(en)ylsuccinic acid containing preferably 8 to 18 carbon atoms in the alk(en)yl chain, or salts thereof.

Further suitable anionic surfactants are, in particular, soaps. Suitable soaps include saturated fatty acid soaps, such as the salts of lauric acid, myristic acid, palmitic acid, stearic acid, hydrogenated erucic acid and behenic acid, and, in particular, mixtures of soaps derived from natural fatty acids, e.g., coconut, palm kernel, or tallow fatty acids.

The anionic surfactants, including the soaps, may be present in the form of their sodium, potassium or ammonium salts and also as soluble salts of organic bases, such as mono-, di- or triethanolamine. Preferably, the anionic surfactants are in the form of their sodium or potassium salts, in particular in the form of the sodium salts. In a further embodiment of the invention, surfactants are used in the form of their magnesium salts.

In the context of the present invention, preference is given to laundry, dishwashing and cleaning product detergent portions comprising from 5 to 50% by weight, preferably from 7.5 to 40% by weight, and in particular from 15 to 25% by weight, of one or more anionic surfactants, based in each case on the detergent portion.

Regarding the selection of the anionic surfactants employed in the laundry, dishwashing or cleaning product detergent portions of the invention, there are no restrictions to be observed that stand in the way of formulation freedom. Preferred laundry, dishwashing or cleaning product detergent portions of the invention, however, have a soap content which exceeds 0.2% by weight, based on the overall weight of the detergent portion. Anionic surfactants for use with preference are the alkylbenzenesulfonates and fatty alcohol sulfates, preferred laundry, dishwashing and cleaning product detergent portions comprising from 2 to 20% by weight, preferably from 2.5 to 15% by weight, and in particular from 5 to 10% by weight, of fatty alcohol sulfate(s), based in each case on the weight of the detergent portion.

Nonionic surfactants used are preferably alkoxylated, advantageously ethoxylated, especially primary, alcohols having preferably 8 to 18 carbon atoms and on average from 1 to 12 mol of ethylene oxide (EO) per mole of alcohol, in which the alcohol radical may be linear or, preferably, methyl-branched in position 2 and/or may comprise linear and methyl-branched radicals in a mixture, as are commonly present in oxo alcohol radicals. In particular, however, preference is given to alcohol ethoxylates containing linear radicals from alcohols of natural origin having 12 to 18 carbon atoms, e.g., from coconut, palm, tallow fatty or oleyl alcohol and on average from 2 to 8 EO per mole of alcohol. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO, and mixtures thereof, and also mixtures of C₁₂₋₁₄ alcohol containing 3 EO and C₁₂₋₁₈ alcohol containing 5 EO. The stated degrees of ethoxylation represent statistical mean values, which for a specific product may be an integer or a fraction. Preferred alcohol ethoxylates have a narrowed homolog distribution (narrow range ethoxylates, NREs). In addition to these nonionic surfactants it is also possible to use fatty alcohols containing more than 12 EO. Examples thereof are tallow fatty alcohol containing 14 EO, 25 EO, 30 EO or 40 EO.

A further class of nonionic surfactants used with preference, which are used either as sole nonionic surfactant or in combination with other nonionic surfactants, are alkoxylated, preferably ethoxylated, or ethoxylated and propoxylated, fatty acid alkyl esters, preferably having 1 to 4 carbon atoms in the alkyl chain, especially fatty acid methyl esters, as are described, for example, in Japanese Patent Application JP 58/217598, or those prepared preferably by the process described in International Patent Application WO-A-90/13533.

A further class of nonionic surfactants which may be used advantageously are the alkyl polyglycosides (APG). Useful alkyl polyglycosides are of the general formula RO(G)_{z}, where R is a linear or branched aliphatic radical, especially an aliphatic radical methyl-branched in position 2, saturated or unsaturated and containing 8 to 22, preferably 12 to 18, carbon atoms, and G is the symbol representing a glycose unit having 5 or 6 carbon atoms, preferably glucose. The degree of glycosidization, z, is between 1.0 and 4.0, preferably between 1.0 and 2.0, and in particular between 1.1 and 1.4.

Preference is given to the use of linear alkyl polyglucosides, i.e., alkyl polyglycosides in which the polyglycosyl residue is a glucose residue and the alkyl radical is an n-alkyl radical.

The laundry, dishwashing or cleaning product detergent portions of the invention may preferably include alkyl polyglycosides, preference being given to APG contents of more than 0.2% by weight in the detergent portions, based on the overall shaped body. Particularly preferred laundry, dishwashing and cleaning product detergent portions comprise APGs in amounts of from 0.2 to 10% by weight, preferably in amounts of from 0.2 to 5% by weight, and in particular in amounts of from 0.5 to 3% by weight.

Nonionic surfactants of the amine oxide type, examples being N-cocoalkyl-N,N-dimethylamine oxide and N-tallowalkyl-N,N-dihydroxyethylamine oxide, and of the fatty acid alkanolamide type, may be also be suitable. The amount of these nonionic surfactants is preferably not more than that of the ethoxylated fatty alcohols, in particular not more than half thereof.

Further suitable surfactants are polyhydroxy fatty acid amides of the formula (I),

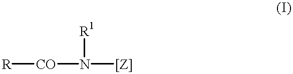

where RCO is an aliphatic acyl radical having 6 to 22 carbon atoms, R¹ is hydrogen or an alkyl or hydroxyalkyl radical having 1 to 4 carbon atoms, and [Z] is a linear or branched polyhydroxyalkyl radical having 3 to 10 carbon atoms and from 3 to 10 hydroxyl groups. The polyhydroxy fatty acid amides are known substances which are customarily obtainable by reductive amination of a reducing sugar with ammonia, an alkylamine or an alkanolamine, and subsequent acylation with a fatty acid, a fatty acid alkyl ester or a fatty acid chloride.

The group of the polyhydroxy fatty acid amides also includes compounds of the formula (II)

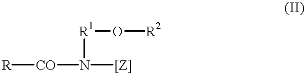

where R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxyalkyl radical having 1 to 8 carbon atoms, preference being given to C₁₋₄ alkyl radicals or phenyl radicals, and [Z] is a linear polyhydroxyalkyl radical whose alkyl chain is substituted by at least two hydroxyl groups, or alkoxylated, preferably ethoxylated or propoxylated, derivatives of said radical.

[Z] is preferably obtained by reductive amination of a reduced sugar, e.g., glucose, fructose, maltose, lactose, galactose, mannose, or xylose. The N-alkoxy- or N-aryloxy-substituted compounds may then be converted to the desired polyhydroxy fatty acid amides, for example, in accordance with the teaching of International Patent Application WO-A-95/07331 by reaction with fatty acid methyl esters in the presence of an alkoxide as catalyst.

Furthermore, it may be preferable to use not only anionic and nonionic surfactants but also cationic surfactants. In this context they are used preferably as wash performance boosters, with only small amounts of cationic surfactants being required. Where cationic surfactants are used, they are present in the compositions preferably in amounts of from 0.01 to 10% by weight, in particular from 0.1 to 3.0% by weight.

Where the laundry, dishwashing or cleaning product detergent portions of the invention comprise laundry detergents, they normally comprise one or more surfactants in total amounts of from 5 to 50% by weight, preferably in amounts of from 10 to 35% by weight, it being possible for surfactants to be present in a greater or smaller amount in subportions of the laundry detergent portions of the invention. In other words: the amount of surfactant is not identical in all subportions; instead, subportions with a relatively high surfactant content and subportions with a relatively low surfactant content may be provided.

Where the laundry, dishwashing or cleaning product detergent portions of the invention comprise cleaning products, especially dishwashing compositions, more preferably warewashing compositions, they normally comprise one or more surfactants in total amounts of from 0.1 to 10% by weight, preferably in amounts of from 0.5 to 5% by weight, it being possible for surfactants to be present in a greater or smaller amount in subportions of the cleaning product or dishwashing detergent portions of the invention. In other words: even in the case of cleaning products or dishwashing compositions, the amount of surfactant is not identical in all subportions; instead, subportions with a relatively high surfactant content and subportions with a relatively low surfactant content may be provided.

Besides the detersive substances, builders are the most important ingredients of laundry, dishwashing and cleaning product detergents. The laundry, dishwashing or cleaning product detergent portions of the invention may comprise all of the builders commonly used in laundry, dishwashing detergent and cleaning product detergents, i.e., in particular, zeolites, silicates, carbonates, organic cobuilders, and—where there are no ecological prejudices against their use—phosphates as well.

Suitable crystalline, layered sodium silicates possess the general formula NaMSiₓO₂ₓ₊₁.yH₂O, where M is sodium or hydrogen, x is a number from 1.9 to 4, y is a number from 0 to 20, and preferred values for x are 2, 3 or 4. Crystalline phyllosilicates of this kind are described, for example, in European Patent Application EP-A-0 164 514. Preferred crystalline phyllosilicates of the formula indicated are those in which M is sodium and x adopts the value 2 or 3. In particular, both βand δ-sodium disilicates Na₂Si₂O₅.yH₂O are preferred, β-sodium disilicate, for example, being obtainable by the process described in International Patent Application WO-A-91/08171.

It is also possible to use amorphous sodium silicates having an Na₂O:SiO₂ modulus of from 1:2 to 1:3.3, preferably from 1:2 to 1:2.8, and in particular from 1:2 to 1:2.6, which are dissolution-retarded and have secondary washing properties. The retardation of dissolution relative to conventional amorphous sodium silicates may have been brought about in a variety of ways—for example, by surface treatment, compounding, compacting, or overdrying. In the context of this invention, the term “amorphous” also embraces “X-ray-amorphous”. This means that in X-ray diffraction experiments the silicates do not yield the sharp X-ray reflections typical of crystalline substances but instead yield at best one or more maxima of the scattered X-radiation, having a width of several degree units of the diffraction angle. However, good builder properties may result, even particularly good builder properties, if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. So-called X-ray-amorphous silicates of this kind, which likewise possess retarded dissolution relative to the conventional waterglasses, are described, for example, in German Patent Application DE-A-44 00 024. Particular preference is given to compacted amorphous silicates, compounded amorphous silicates, and overdried X-ray-amorphous silicates.

Any finely crystalline, synthetic zeolite used, containing bound water, is preferably zeolite A and/or P. A particularly preferred zeolite of type P is zeolite MAP (e.g., commercial product Doucil A24 from Crosfield). Also suitable, however, are zeolite X and also mixtures of the zeolites A, X and/or P. A product available commercially and able to be used with preference in the context of the present invention, for example, is a cocrystallizate of zeolite X and zeolite A (approximately 80% by weight zeolite X), which is sold by CONDEA Augusta S.p.A. under the brand name VEGOBOND AX® and may be described by the formula

nNa₂O.(1−n)K₂O.Al₂O₃.(2-2.5)SiO₂.(3.5-5.5)H₂O.

Suitable zeolites have an average particle size of less than 10 μm (volume distribution; measurement method: Coulter counter) and contain preferably from 18 to 22% by weight, in particular from 20 to 22% by weight, of bound water.

Of course, in laundry detergents the widely known phosphates may also be used as builder substances, provided such a use is not to be avoided on ecological grounds. The sodium salts of the ortho-phosphates, the pyrophosphates, and in particular the tripolyphosphates are particularly suitable.

Organic builder substances which may be used are, for example, the polycarboxylic acids, usable in the form of their sodium salts, the term polycarboxylic acids meaning those carboxylic acids which carry more than one acid function. Examples of these are citric acid, adipic acid, succinic acid, glutaric acid, malic acid, tartaric acid, maleic acid, fumaric acid, sugar acids, amino carboxylic acids, nitrilotriacetic acid (NTA), provided such use is not objectionable on ecological grounds, and also mixtures thereof. Preferred salts are the salts of the polycarboxylic acids such as citric acid, adipic acid, succinic acid, glutaric acid, tartaric acid, sugar acids, and mixtures thereof. The acids per se may also be used. In addition to their builder effect, the acids typically also possess the property of an acidifying component and thus also serve to establish a lower and milder pH of laundry and cleaning product detergent portions in accordance with the invention. In this context, mention may be made in particular of citric acid, succinic acid, glutaric acid, adipic acid, gluconic acid, and any desired mixtures thereof.

Also suitable as builders are polymeric polycarboxylates. These are, for example, the alkali metal salts of polyacrylic acid or of polymethacrylic acid, examples being those having a relative molecular mass of from 500 to 70 000 g/mol.

The molecular masses reported for polymeric polycarboxylates, for the purposes of the present invention, are weight-average molecular masses, M_{w}, of the respective acid form, determined basically by means of gel permeation chromatography (GPC) using a UV detector. The measurement was made against an external polyacrylic acid standard, which owing to its structural similarity to the polymers under investigation provides realistic molecular weight values. These figures differ markedly from the molecular weight values obtained using poly-styrenesulfonic acids as the standard. The molecular masses measured against polystyrenesulfonic acids are generally much higher than the molecular masses reported in the context of the present invention.

Suitable polymers are, in particular, polyacrylates, which preferably have a molecular mass of from 2 000 to 20 000 g/mol. Owing to their superior solubility, preference in this group may be given in turn to the short-chain polyacrylates, which have molecular masses of from 2 000 to 10 000 g/mol, and with particular preference from 3 000 to 5 000 g/mol.

Also suitable are copolymeric polycarboxylates, especially those of acrylic acid with methacrylic acid and of acrylic acid or methacrylic acid with maleic acid. Copolymers which have been found particularly suitable are those of acrylic acid with maleic acid which contain from 50 to 90% by weight acrylic acid and from 50 to 10% by weight maleic acid. Their relative molecular mass, based on free acids, is generally from 2 000 to 70 000 g/mol, preferably from 20 000 to 50 000 g/mol, and in particular from 30 000 to 40 000 g/mol.

The (co)polymeric polycarboxylates can be used either as powders or as aqueous solutions. The (co)polymeric polycarboxylate content of the laundry, dishwashing or cleaning product detergent portions is preferably from 0.5 to 20% by weight, in particular from 3 to 10% by weight.

In order to improve the solubility in water, the polymers may also contain allylsulfonic acids, such as in EP-B-0 727 448, allyloxybenzenesulfonic acid and methallylsulfonic acid, for example, as monomers.

Particular preference is also given to biodegradable polymers comprising more than two different monomer units, examples being those as in DE-A 43 00 772 comprising, as monomers, salts of acrylic acid and of maleic acid, and also vinyl alcohol or vinyl alcohol derivatives, or those as in DE-C 42 21 381 comprising, as monomers, salts of acrylic acid and of 2-alkylallylsulfonic acid, and also sugar derivatives.

Further preferred copolymers are those described in German Patent Applications DE-A-43 03 320 and DE-A-44 17 734, whose monomers are preferably acrolein and acrylic acid/acrylic acid salts, and, respectively, acrolein and vinyl acetate.

Similarly, further preferred builder substances that may be mentioned include polymeric amino dicarboxylic acids, their salts or their precursor substances. Particular preference is given to polyaspartic acids and their salts and derivatives, which are disclosed in German Patent Application DE-A-195 40 086 to have not only cobuilder properties but also a bleach-stabilizing action.

Further suitable builder substances are polyacetals, which may be obtained by reacting dialdehydes with polyol carboxylic acids having 5 to 7 carbon atoms and at least 3 hydroxyl groups, as described for example in EP-A 0 280 223. Preferred polyacetals are obtained from dialdehydes such as glyoxal, glutaraldehyde, terephthalaldehyde and mixtures thereof and from polyol carboxylic acids such as gluconic acid and/or glucoheptonic acid.

Further suitable organic builder substances are dextrins, examples being oligomers and polymers of carbohydrates, which may be obtained by partial hydrolysis of starches. The hydrolysis can be conducted by customary processes; for example, acid-catalyzed or enzyme-catalyzed processes. The hydrolysis products preferably have average molecular masses in the range from 400 to 500 000 g/mol. Preference is given here to a polysaccharide having a dextrose equivalent (DE) in the range from 0.5 to 40, in particular from 2 to 30, DE being a common measure of the reducing effect of a polysaccharide in comparison to dextrose, which possesses a DE of 100. It is possible to use both maltodextrins having a DE of between 3 and 20 and dried glucose syrups having a DE of between 20 and 37, and also so-called yellow dextrins and white dextrins having higher molecular masses, in the range from 2 000 to 30 000 g/mol. A preferred dextrin is described in GB-A 94 19 091.

The oxidized derivatives of such dextrins comprise their products of reaction with oxidizing agents which are able to oxidize at least one alcohol function of the saccharide ring to the carboxylic acid function. Oxidized dextrins of this kind, and processes for preparing them, are known, for example, from European Patent Applications EP-A-0 232 202, EP-A-0 427 349, EP-A-0 472 042 and EP-A-0 542 496 and from International Patent Applications WO 92/18 542, WO 93/08 251, WO 93/16 110, WO 94/28 030, WO 95/07 303, WO 95/12 619 and WO 95/20 608. Likewise suitable is an oxidized oligosaccharide in accordance with German Patent Application DE-A 196 00 018. A product oxidized at C₆ of the saccharide ring may be particularly advantageous.

Oxydisuccinates and other derivatives of disuccinates, preferably ethylenediamine disuccinate, are further suitable cobuilders. Ethylenediamine N,N′-disuccinate (EDDS), whose synthesis is described for example in the document U.S. Pat. No. 3,158,615, is used preferably in the form of its sodium or magnesium salts. Further preference in this context is given to glycerol disuccinates and glycerol trisuccinates as well, as described for example in U.S. Pat. No. 4,524,009 and U.S. Pat. No. 4,639,325, in EP-A 0 150 930 and in JP-A 93/339,896. Suitable use amounts in formulations containing zeolite and/or silicate are from 3 to 15% by weight.

Examples of further useful organic cobuilders are acetylated hydroxy carboxylic acids and their salts, which may also be present in lactone form and which contain at least 4 carbon atoms, at least one hydroxyl group, and not more than two acid groups. Such cobuilders are described, for example, in International Patent Application WO 95/20 029.

A further class of substance having cobuilder properties is represented by the phosphonates. The phosphonates in question are, in particular, hydroxyalkane- and aminoalkanephosphonates. Among the hydroxyalkanephosphonates, 1-hydroxyethane-1,1-diphosphonate (HEDP) is of particular importance as a cobuilder. It is used preferably as the sodium salt, the disodium salt being neutral and the tetrasodium salt giving an alkaline (pH 9) reaction. Suitable aminoalkanephosphonates are preferably ethylenediamine-tetramethylenephosphonate (EDTMP), diethylenetriamine-pentamethylenephosphonate (DTPMP), and their higher homologs. They are used preferably in the form of the neutrally reacting sodium salts, e.g., as the hexasodium salt of EDTMP or as the hepta- and octa-sodium salt of DTPMP. As a builder in this case, preference is given to using HEDP from the class of the phosphonates. Furthermore, the aminoalkanephosphonates possess a pronounced heavy metal binding capacity. Accordingly, and especially if the laundry, dishwashing and cleaning product detergent portions of the invention also contain bleach, it may be preferred to use aminoalkanephosphonates, especially DTPMP, or to use mixtures of said phosphonates.

Furthermore, all compounds capable of forming complexes with alkaline earth metal ions may be used as cobuilders.

In addition to the abovementioned constituents, surfactant and builder, the laundry, dishwashing and cleaning product detergent portions of the invention may further comprise further customary laundry, dishwashing and cleaning product detergent ingredients from the group consisting of bleaches, bleach activators, enzymes, fragrances, perfume carriers, fluorescers, dyes, foam inhibitors, silicone oils, antiredeposition agents, optical brighteners, graying inhibitors, color transfer inhibitors, and corrosion inhibitors.

Among the compounds used as bleaches which yield H₂O₂ in water, particular importance is possessed by sodium perborate tetrahydrate and sodium perborate monohydrate. Further bleaches which may be used are, for example, sodium percarbonate, peroxypyrophosphates, citrate perhydrates, and H₂O₂-donating peracidic salts or peracids, such as perbenzoates, peroxophthalates, diperazelaic acid, phthaloiminoper acid or diperdodecanedioic acid. If cleaning or bleach formulations are produced for machine dishwashing, bleaches from the group of organic bleaches may also be used. Typical organic bleaches are the diacyl peroxides, such as dibenzoyl peroxide, for example. Further typical organic bleaches are the peroxy acids, particular examples being the alkyl peroxy acids and the aryl peroxy acids. Preferred representatives are (a) peroxybenzoic acid and its ring-substituted derivatives, such as alkylperoxybenzoic acids, and also peroxy-α-naphthoic acid and magnesium monoperphthalate, (b) aliphatic or substituted aliphatic peroxy acids, such as peroxylauric acid, peroxystearic acid, ε-phthalimidoperoxy caproic acid [phthaloiminoperoxy-hexanoic acid (PAP)], o-carboxybenzamidoperoxycaproic acid, N-nonenylamidoperadipic acid and N-nonenylamidopersuccinates, and (c) aliphatic and araliphatic peroxy dicarboxylic acids, such as 1,12-diperoxydecane-dicarboxylic acid, 1,9-diperoxyazelaic acid, diperoxy-sebacic acid, diperoxybrassylic acid, the diperoxyphthalic acids, 2-decyldiperoxybutane-1,4-dioic acid and N,N-terephthaloyldi(6-aminopercaproic acid) may be used.

Bleaches used in compositions for machine dishwashing may also be substances which release chlorine or bromine. Among suitable chlorine- or bromine-releasing materials, examples include heterocyclic N-bromoamides and N-chloroamides, examples being trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

In order to achieve an improved bleaching action when washing or cleaning at temperatures of 60° C. and below, it is possible to incorporate bleach activators into the laundry, dishwashing and cleaning product detergent portions of the invention. Bleach activators which may be used are compounds which under perhydrolysis conditions give rise to aliphatic peroxo carboxylic acids having preferably 1 to 10 carbon atoms, in particular 2 to 4 carbon atoms, and/or substituted or unsubstituted perbenzoic acid. Suitable substances are those which carry O-acyl and/or N-acyl groups of the stated number of carbon atoms, and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acyl imides, especially N-nonanoylsuccinimide (NOSI), acylated phenolsulfonates, especially n-nonanoyl- or isononanoyloxybenzenesulfonate (n- or iso-NOBS), carboxylic anhydrides, especially phthalic anhydride, acylated polyhydric alcohols, especially triacetin, ethylene glycol diacetate, and 2,5-diacetoxy-2,5-dihydrofuran.

In addition to the conventional bleach activators, or instead of them, it is also possible to incorporate what are known as bleaching catalysts into the laundry, dishwashing or cleaning product detergent portions. These substances are bleach-boosting transition metal salts or transition metal complexes such as, for example, Mn-, Fe-, Co-, Ru- or Mo-salen complexes or -carbonyl complexes. Other bleaching catalysts which can be used include Mn, Fe, Co, Ru, Mo, Ti, V and Cu complexes with N-containing tripod ligands, and also Co-, Fe-, Cu- and Ru-amine complexes.

Suitable enzymes include those from the class of the proteases, lipases, amylases, cellulases, and mixtures of said enzymes. Especially suitable enzymatic active substances are those obtained from bacterial strains or fungi, such as Bacillus subtilis, Bacillus licheniformis, and Streptomyces griseus. Preference is given to the use of proteases of the subtilisin type, and especially to proteases obtained from Bacillus lentus. Of particular interest in this context are enzyme mixtures, examples being those of protease and amylase or protease and lipase or protease and cellulase or cellulase and lipase, or of protease, amylase and lipase, or protease, lipase and cellulase, but especially cellulase-containing mixtures. Peroxidases or oxidases have also proven suitable in some cases. The enzymes may be adsorbed on carrier substances and/or embedded in coating substances in order to protect them against premature decomposition. The proportion of the enzymes, enzyme mixtures or enzyme granules in the compositions of the invention may be, for example, from about 0.1 to 5% by weight, preferably from 0.1 to about 2% by weight.

In accordance with the prior art, enzymes are added primarily to a cleaning product formulation, especially to a dishwashing composition, which is intended for the main wash cycle. A disadvantage in this case was that the activity optimum of enzymes used restricted the choice of temperature and also that problems occurred in connection with the stability of the enzymes in the strongly alkaline medium. With the laundry, dishwashing or cleaning product detergent portions of the invention it is possible to use enzymes in the prewash cycle as well and so to utilize the prewash cycle, in addition to the main wash cycle, for the enzymes to act on ware soiling.

In accordance with the invention, therefore, it is particularly preferred to add enzymes to the detersive formulation or subportion—intended for the prewash cycle—of a cleaning product detergent portion and then—with further preference—to enclose such a formulation with a material which dissolves in water even at low temperature, in order, for example, to protect the enzyme-containing formulation against a loss of activity caused by immediate-environment conditions. With further preference, the enzymes are optimized for use under the conditions of the prewash cycle, i.e., in cold water, for example.

The dishwashing detergent or cleaning product detergent portions of the invention may be advantageous when the enzyme formulations are in liquid form, as are available commercially in some cases, since in that case it is possible to expect a rapid action which takes place as early as in the prewash cycle (which is relatively short and is carried out in cold water) Even when—as is usual—the enzymes are used in solid form and are provided with an enclosure of a water-soluble material which is soluble even in cold water, the enzymes may develop their activity even before the main wash cycle or main cleaning operation. An advantage of using an enclosure comprising water-soluble material, especially comprising cold-water-soluble material, is that the enzyme(s) acts(act) rapidly in cold water following dissolution of the enclosure. By this means it is possible to extend their activity time, to the benefit of the wash.

In accordance with one particularly preferred embodiment, the laundry, dishwashing or cleaning product detergent portions of the invention comprise further additives as known from the prior art as additives for laundry, dishwashing and cleaning product detergent formulations. These additives may be added to either one or more, or else if necessary to all, subportions (detersive formulations) of the laundry, dishwashing or cleaning product detergent portions of the invention, or may—as described in the parallel pending patent application No. 199 29 098.9 with the title “Active substance portion pack”—be incorporated into water-soluble materials comprising the detersive formulations, i.e., for example, into water-soluble enclosure films, or else into the capsules or coatings of the invention.

One preferred group of additives used in accordance with the invention are optical brighteners. In this case it is possible to use the optical brighteners customary in laundry detergents. They are added as an aqueous solution or a solution in an organic solvent to the polymer solution which is converted into the film, or are added in solid or liquid form to a subportion (detersive formulation) of a detergent. Examples of optical brighteners are derivatives of diaminostilbenedisulfonic acid and the alkali metal salts thereof. Suitable, for example, are salts of 4,4′-bis(2-anilino-4-morpholino-1,3,5-triazinyl-6-amino)stilbene-2,2′-disulfonic acid or compounds of similar structure carrying a diethanolamino group, a methylamino group, and anilino group, or a 2-methoxyethylamino group in place of the morpholino group. Moreover, brighteners of the substituted diphenylstyryl type may be present in the subportions (detersive formulations) of the laundry, dishwashing or cleaning product detergent portions of the invention, examples being the alkali metal salts of 4,4′-bis(2-sulfostyryl)biphenyl, 4,4′-bis(4-chloro-3-sulfostyryl)-biphenyl or 4-(4-chlorostyryl)-4′-(2-sulfostyryl)biphenyl. Mixtures of the aforementioned brighteners may also be used.

A further group of additives which is preferred in accordance with the invention are UV protection substances. These are substances which during the washing process or during the subsequent fabric softening process are released in the wash liquor and accumulate on the fiber, subsequently achieving a UV protection effect. The products available commercially under the designation Tinosorb from Ciba Specialty Chemicals are suitable.

Further additives which are conceivable and are preferred in specific embodiments are surfactants, which may in particular influence the solubility of the water-soluble film, but may also control the wettability thereof and the formation of foam during dissolution, and foam inhibitors, and also bitter substances, which may prevent accidental swallowing of such packaging or parts of such packaging by children.

A further group of additives which is preferred in accordance with the invention are dyes, especially water-soluble or water-dispersible dyes. Preference is given here to dyes as commonly used in order to enhance the visual appeal of the product in laundry detergents, dishwashing detergents, and cleaning product detergents. The selection of such dyes causes no difficulty to the skilled worker, especially since customary dyes of this kind have a high level of storage stability and insensitivity to the other ingredients of the detersive formulations, and with respect to light, and also have no pronounced affinity for textile fibers, so as not to stain them. In accordance with the invention, the dyes are present in amounts of less than 0.01% by weight in the laundry, dishwashing or cleaning product detergent portions.

A further class of additives which may be added in accordance with the invention to the laundry, dishwashing or cleaning product detergent portions are polymers. Suitable such polymers include, firstly, polymers which in the course of washing or cleaning exhibit cobuilder properties, i.e., for example, polyacrylic acids, including modified polyacrylic acids, or corresponding copolymers. Another group of polymers are polyvinylpyrrolidone and other graying inhibitors, such as polyvinylpyrrolidone copolymers, cellulose ethers, and the like. In accordance with another embodiment of the invention, suitable polymers also include what are known as soil repellents, as are known to the skilled laundry, dishwashing or cleaning products worker and described in detail below.

Another group of additives are bleaching catalysts, especially bleaching catalysts for machine dishwashing compositions or laundry detergents. Use is made here of complexes of manganese and of cobalt, especially with nitrogenous ligands.

A further group of additives which is preferred in the context of the invention is silver protectants. This group comprises a large number of usually cyclic organic compounds, which again are familiar to the skilled worker in question here and which contribute to preventing the tarnishing of articles containing silver during the cleaning process. Specific examples may be triazoles, benzotriazoles, and complexes thereof with metals such as Mn, Co, Zn, Fe, Mo, W or Cu, for example.

As further additives in accordance with the invention the laundry, dishwashing or cleaning product detergent portions may also comprise what are known as soil repellents, i.e., polymers which attach to fibers or hard surfaces (to porcelain and glass, for example), which have a positive effect on the capacity for oil and fat to be washed off from textiles, and which therefore act specifically to counter resoiling. This effect is particularly marked if a textile or a hard article (porcelain, glass) which has already been washed or cleaned a number of times beforehand with a laundry, dishwashing or cleaning product detergent of the invention comprising this oil- and fat-dissolving component becomes soiled. The preferred oil- and fat-dissolving components include, for example, nonionic cellulose ethers such as methylcellulose and methylhydroxypropylcellulose having a methoxy group content of from 15 to 30% by weight and a hydroxypropoxy group content of from 1 to 15% by weight, based in each case on the nonionic cellulose ether, and also the prior art polymers of phthalic acid and/or of terephthalic acid and/or of derivatives thereof, especially polymers of ethylene terephthalates and/or polyethylene glycol terephthalates or anionically and/or nonionically modified derivatives of these. Of these compounds, particular preference is given to the sulfonated derivatives of the phthalic acid and terephthalic acid polymers.

All of these additives are added to the laundry, dishwashing or cleaning product detergent portions of the invention in amounts of not more than 30% by weight, preferably from 2 to 20% by weight. As already stated, the addition may also be made to a material of a water-soluble enclosure which encloses the—or one of the—detersive formulations. In order to maintain the balance of the recipe, therefore, it is possible for the skilled worker either to increase the weight of the polymer material for the enclosure, in order to utilize the depot effect which is achieved in accordance with the invention, or else to keep the aforementioned additives additionally, at least fractionally, in the remaining detersive formulation. This, however, is less preferred.

Fragrances are added to the laundry, dishwashing or cleaning product detergent portions of the invention in order to enhance overall esthetic appeal of the products and to provide the consumer with not only the performance (fabric softening, clear rinsing) but also a sensorially typical and unmistakable product. As perfume oils or fragrances it is possible to use individual odorant compounds, examples being the synthetic products of the ester, ether, aldehyde, ketone, alcohol, and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether. The aldehydes include, for example, the linear alkanals having 8 to 18 carbon atoms, citral, citronellal, citronellyloxyacetaldehyde, cyclamen aldehyde, hydroxycitronellal, lilial and bourgeonal.

The ketones include, for example, the ionones, α-isomethylionone and methyl cedryl ketone. The alcohols include anethole, citronellol, eugenol, geraniol, linalool, phenylethyl alcohol, and terpineol. The hydrocarbons include primarily terpenes such as limonene and pinene. Preference is given to the use of mixtures of different odorants, which are blended so that together they produce an appealing fragrance. Such perfume oils may also contain natural odorant mixtures, as obtainable from plant sources. Examples are pine oil, citrus oil, jasmine oil, patchouli oil, rose oil or ylang-ylang oil. Likewise suitable are nutmeg oil, sage oil, chamomile oil, clove oil, balm oil, mint oil, cinnamon leaf oil, lime blossom oil, juniperberry oil, vetiver oil, olibanum oil, galbanum oil and labdanum oil, and also orange blossom oil, neroli oil, orange peel oil, and sandalwood oil.

Normally, the fragrance content is in the region of up to 2% by weight of the overall detergent portion.

The fragrances may be incorporated directly into the detersive formulations; alternatively, it may be advantageous to apply the fragrances to carriers which intensify the adhesion of the perfume on the laundry and, by means of slower fragrance release, ensure long-lasting fragrance of the textiles. Materials which have become established as such carriers are, for example, cyclodextrins, it being possible in addition for the cyclodextrin-perfume complexes to be additionally coated with further auxiliaries.

The perfumes and fragrances may in principle be present in any of the subportions (detersive formulations) of the laundry, dishwashing or cleaning product detergent portions of the invention. With particular preference, however, they are present—in a laundry detergent—in a detergent subportion intended for the afterwash cycle or fabric softening cycle or rinse cycle, or—in a cleaning product, especially in a dishwashing composition—in a detergent subportion intended for the afterwash cycle or rinse cycle. In accordance with the invention, therefore, they must be enveloped by a material which is water-soluble only under the conditions (especially the temperature) of the afterwash cycle, and which is water-insoluble under the conditions (especially temperature) of the preceding wash cycles, especially by a corresponding film or capsule or by a corresponding coating. In accordance with the invention this can be done, for example, using a pouch consisting of a plurality of chambers and made from films differing in their water-solubility.

To combat microorganisms, the laundry, dishwashing or cleaning product detergent portions of the invention may comprise active antimicrobial substances. A distinction is made here, according to antimicrobial spectrum and mechanism of action, between bacteriostats and bacteriocides, fungiostats and fungicides, etc. Important substances from these groups are, for example, benzalkonium chlorides, alkylarylsulfonates, halophenols, and phenylmercuric acetate. The terms antimicrobial activity and antimicrobial substance in the context of the teaching of the invention have the customary meaning in the art, which is given, for example, by K. H. Wallhäusser in “Praxis der Sterilisation, Desinfektion—Konservierung: Keimidentifizierung—Betriebshygiene” (5th edition—Stuttgart; New York: Thieme, 1995), it being possible to use all of the substances described therein possessing antimicrobial activity. Suitable active antimicrobial substances are preferably selected from the groups of the alcohols, amines, aldehydes, antimicrobial acids and their salts, carboxylic esters, acid amides, phenols, phenol derivatives, biphenyls, diphenylalkanes, urea derivatives, oxygen and nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propyl butylcarbamate, iodine, iodophores, peroxo compounds, halogen compounds, and any desired mixtures of the above compounds and/or groups of compounds.

The active antimicrobial substance may be selected from the group of the compounds given below, it being possible to use one or more of the stated compounds: ethanol, n-propanol, i-propanol, 1,3-butanediol, phenoxyethanol, 1,2-propylene glycol, glycerol, undecylenic acid, benzoic acid, salicylic acid, dihydroacetic acid, o-phenylphenol, N-methylmorpholine-acetonitrile (MMA), 2-benzyl-4-chlorophenol, 2,2′-methylenebis(6-bromo-4-chlorophenol), 4,4′-dichloro-2′-hydroxydiphenyl ether (diclosan), 2,4,4′-trichloro-2′-hydroxydiphenyl ether (triclosan), chlorhexidine, N-(4-chlorophenyl)-N-(3,4-dichlorophenyl)urea, N,N′-(l,10-decanediyldi-1-pyridinyl-4-ylidene)bis(1-octanamine) dihydrochloride, N,N′-bis(4-chlorophenyl)-3,12-diimino-2,4,11,13-tetraazatetradecanediimideamide, glucoprotamines, antimicrobial surface-active quaternary compounds, guanidines, including the biguanidines and polyguanidines, such as, for example, 1,6-bis(2-ethylhexylbiguanidohexane) dihydrochloride, 1, 6-di (N₁,N₁′-phenyldiguanido-N₅,N₅′-)hexane tetrahydrochloride, 1,6-di (N₁, Nₗ′-phenyl -N₁, N₁′-methyldiguanido-N₅, N₅′-) hexane dihydrochloride, 1,6-di (N₁,N₁′-o-chlorophenyldiguanido-N₅,N₅′-)hexane dihydrochloride, 1,6-di(N₁,N₁′-2,6-di-chlorophenyldiguanido-N₅,N₅′-) hexane dihydrochloride, 1,6-di-[N₁,N₁′-beta-(p-methoxyphenyl)diguanido-N₅,N₅′-]-hexane dihydrochloride, 1,6-di(N₁,N₁′-alpha-methylbetaphenyldiguanido-N₅,N₅′-) hexane dihydrochloride, 1,6-di (N₁,N₁′-p-nitrophenyldiguanido-N₅,N₅′-) hexane di-hydrochloride, omega, omega′-di (N₁,N₁′-phenyldiguanido-N₅,N₅′-)di-n-propyl ether dihydrochloride, omega,omega′-di (N₁, N₁′-p-chlorophenyldiguanido-N₅, N₅′-) di-n-propyl ether tetrahydrochloride, 1,6-di (N₁,N₁′-2,4-dichloro-phenyldiguanido-N₅,N₅′-)hexane tetrahydrochloride, 1,6-di (N₁,N₁′-p-methylphenyldiguanido-N₅,N₅′-) hexane di-hydrochloride, 1,6-di(N₁,N₁′-2,4,5-trichlorophenyldi-guanido-N₅,N₅′-) hexane tetrahydrochloride, 1,6-di[N₁,N₁′-alpha-(p-chlorophenyl)ethyldiguanido-N₅,N₅′-]-hexane dihydrochloride, omega,omega-di (N₁,N₁′-p-chlorophenyldiguanido-N₅,N₅′-)m-xylene dihydrochloride, 1,12-di(N₁,N₁′-p-chlorophenyldiguanido-N₅,N₅′-)dodecane dihydrochloride, 1,10-di (N₁,N₁′-phenyldiguanido-N₅,N₅′-) decane tetrahydrochloride, 1,12-di (N₁,N₁′-phenyl-diguanido-N₅,N₅′-) dodecane tetrahydrochloride, 1,6-di(N₁N₁′′-o-chlorophenyldiguanido-N₅,N₅′-)hexane dihydro-chloride, 1,6-di(N₁,N₁′-o-chlorophenyldiguanido-N₅,N₅′-)-hexane tetrahydrochloride, ethylenebis(1-tolyl-biguanide), ethylenebis(p-tolylbiguanide), ethylenebis-(3,5-dimethylphenylbiguanide), ethylenebis (p-tert-amyl-phenylbiguanide), ethylenebis(nonylphenylbiguanide), ethylenebis(phenylbiguanide), ethylenebis(N-butyl-phenylbiguanide), ethylenebis(2,5-die-thoxyphenylbiguanide), ethylenebis(2,4-dimethylpheny-lbiguanide), ethylenebis(o-diphenylbiguanide), ethy-lenebis(mixed-amyl-naphthylbiguanide), N-butylethy-lenebis(phenylbiguanide), trimethylenebis(o-toly-lbiguanide), N-butyltrimethylenebis(phenylbiguanide) and the corresponding salts such as acetates, gluconates, hydrochlorides, hydrobromides, citrates, bisulfites, fluorides, polymaleates, N-coco-alkylsarcosinates, phosphites, hypophosphites, perfluorooctanoates, silicates, sorbates, salicylates, maleates, tartrates, fumarates, ethylenediamine-tetraacetates, iminodiacetates, cinnamates, thio-cyanates, arginates, pyromellitates, tetracarboxy-butyrates, benzoates, glutarates, monofluorophosphates, perfluoropropionates, and any desired mixtures thereof. Also suitable are halogenated xylene and cresol derivatives, such as p-chloro-meta-cresol or p-chloro-meta-xylene, and also natural active antimicrobial substances of plant origin (e.g., from spices or herbs), animal origin, and microbial origin. With preference it is possible to use antimicrobial surface-active quaternary compounds, a natural active antimicrobial substance of plant origin and/or a natural active antimicrobial substance of animal origin, very great preference being given to at least one active natural antimicrobial substance of plant origin from the group consisting of caffeine, theobromine and theophylline and also essential oils such as eugenol, thymol and geraniol, and/or at least one natural active antimicrobial substance of animal origin from the group consisting of enzymes such as milk protein, lysozyme and lactoperoxidase, and/or at least one antimicrobial surface-active quaternary compound containing an ammonium, sulfonium, phosphonium, iodonium or arsonium group, peroxo compounds, and chloro compounds. It is also possible to use substances of microbial origin, known as bacteriocins.

The quaternary ammonium compounds (QAC) suitable as active antimicrobial substances have the general formula (R¹) (R²)(R³) (R⁴)N⁺X⁻ where R¹ to R⁴ are identical or different C₁ to C₂₂ alkyl radicals, C₇ to C₂₈ aralkyl radicals or heterocyclic radicals, where two—or, in the case of an aromatic incorporation as in pyridine, even three—radicals, together with the nitrogen atom, form the heterocycle, e.g., a pyridinium or imidazolinium compound, and X⁻ are halide ions, sulfate ions, hydroxide ions or similar ions. For an optimum antimicrobial activity, at least one of the radicals preferably has a chain length of from 8 to 18, in particular from 12 to 16, carbon atoms.

QACs may be prepared by reacting tertiary amines with alkylating agents, such as methyl chloride, benzyl chloride, dimethyl sulfate, dodecyl bromide, but also ethylene oxide, for example. The alkylation of tertiary amines with a long alkyl radical and two methyl groups is particularly easy. The quaternization of tertiary amines having two long radicals and one methyl group may also be carried out under mild conditions with the aid of methyl chloride. Amines having three long alkyl radicals or hydroxy-substituted alkyl radicals are relatively unreactive and are preferably quaternized using dimethyl sulfate.

Suitable QACs are, for example, benzalkonium chloride (N-alkyl-N,N-dimethylbenzylammonium chloride, CAS No. 8001-54-5), benzalkone B (m,p-dichlorobenzyl-dimethyl-C12-alkylammonium chloride, CAS No. 58390-78-6), benzoxonium chloride (benzyldodecylbis(2-hydroxyethyl)ammonium chloride), cetrimonium bromide (N-hexadecyl-N,N-trimethylammonium bromide, CAS No. 57-09-0), benzetonium chloride (N,N-dimethyl-N-[2-[2-[p-(1,1,3,3-tetramethylbutyl)phenoxy]ethoxy]ethyl]-benzylammonium chloride, CAS No. 121-54-0), dialkyldimethylammonium chlorides such as di-n-decyldimethylammonium chloride (CAS No. 7173-51-5-5), didecyldimethylammonium bromide (CAS No. 2390-68-3), dioctyldimethylammonium chloride, 1-cetylpyridinium chloride (CAS No. 123-03-5) and thiazoline iodide (CAS No. 15764-48-1), and mixtures thereof. Particularly preferred QACs are the benzalkonium chlorides having C₈ to C₁₈ alkyl radicals, especially C₁₂ to C₁₄ alkyl-benzyldimethylammonium chloride.

Benzalkonium halides and/or substituted benzalkonium halides are available commercially, for example, as Barquat® from Lonza, Marquat® from Mason, Variquat® from Witco/Sherex and Hyamine® from Lonza, and also Bardac® from Lonza. Further commercially available active antimicrobial substances are N-(3-chloroallyl)hexaminium chloride such as Dowicide® and Dowicil® from Dow, benzethonium chloride such as Hyamine® 1622 from Rohm & Haas, methylbenzethonium chloride such as Hyamine® 10× from Rohm & Haas, and cetylpyridinium chloride such as cepacol chloride from Merrell Labs.

The active antimicrobial substances are used in laundry, dishwashing or cleaning product detergent portions of the invention in amounts of from 0.0001% by weight to 1% by weight, preferably from 0.001% by weight to 0.8% by weight, with particular preference from 0.005% by weight to 0.3% by weight, and in particular from 0.01 to 0.2% by weight.

In accordance with the invention, the laundry, dishwashing or cleaning product detergent portions comprise at least two, but if desired even more than two, detersive components or formulations, for example, those as described in detail above, which are intended for release into the liquor at different points in time. For example, in the case of a laundry detergent portion of the invention, these may be detersive formulations or components for the prewash cycle of a wash operation on the one hand and for the main wash cycle of a wash operation on the other hand, or detersive components or formulations for the main wash cycle of a wash operation on the one hand and for the afterwash cycle of a wash operation on the other hand. In this case it is preferred for the respective cycles to be cycles of a wash operation in a washing machine. In the case of a dishwashing detergent according to the invention—to name a further preferred example of the invention—the at least two components may be detersive components or formulations for the prewash cycle and main wash cycle or for the main wash cycle and afterwash cycle of a wash operation, preferably in a dishwasher.

The laundry, dishwashing or cleaning product detergent portion of the invention, comprising two or more detersive components of which at least two are to be released into the liquor at different points in time of a washing or cleaning operation, comprise at least one release controlling (physico)chemical switch which is not subject or not exclusively subject to temperature control.

By the term “(physico)chemical switch” in the context of the present invention, in the most general embodiment, it is understood that the laundry, dishwashing or cleaning product detergent portion may be induced to release at least two detersive components it comprises into the respective liquor at different points in time of the washing or cleaning operation by means of appropriate components it comprises, on the basis of one or more changes in its surrounding wash liquor or cleaning liquor, this change or changes being controllable by the user in accordance with the conditions or in accordance with the desired results—for example, in accordance with the wash program or cleaning program of a machine.

In preferred embodiments of the invention, such components may, for example, be structural components. By this is meant that the structural composition of the laundry, dishwashing or cleaning product detergent portion is such that release of one or more detersive components of the respective portion into the wash liquor or cleaning liquor may take place independently of one or more other detersive components of the respective portion. In one preferred embodiment of the wash liquor or cleaning liquor of the invention, this structural composition may be a composition in layers or in disks, in which—to name only one of numerous conceivable and practicable examples, without restricting the invention hereto—one or more detersive components of a laundry, dishwashing or cleaning product detergent portion, which is or are to be released into the liquor later, is or are present in one or more layers of a portion present in the form of a tablet, said layer or layers not being exposed to the ingress of an aqueous liquor until later than one or more other detersive components of a laundry, dishwashing or cleaning product detergent portion which is or are to be released into the liquor at an earlier point in time of the washing or cleaning operation. The structural components may also comprise, for example, a composition in which particles of individual (or else of two or more) detersive components, or aggregates of such particles, which are to be released into the liquor at a late point in time of a washing or cleaning operation are surrounded by one or more layers of one or more detersive components which may be released into the liquor at an early point in time. Similarly, the structural components may comprise a composition in which one or more components for later release into the respective liquor is or are surrounded by a coating which dissolves poorly in water or dissolves only under certain conditions in water, but one or more components for earlier release into the respective liquor is or are not so surrounded, or in which one or more components for release into the liquor at a later point in time of the washing or cleaning operation has or have been compacted to a greater extent, and/or more closely, to an agglomerate of particles or one or more layers thereof or to a tablet or one or more layers thereof, than has or have one or more other components of a laundry, dishwashing or cleaning product detergent portion which is or are to be released into the liquor at an earlier point in time. Of course, combinations of two or more such (or else different) structural components are possible.

In another preferred embodiment of the laundry, dishwashing or cleaning product detergent portion of the invention, the (physico)chemical switch(es) controlling the release of at least one detersive component is/are one or more structural or substantive components of the laundry, dishwashing or cleaning product detergent portion. This means that the laundry, dishwashing or cleaning product detergent portion comprises at least one substance component which in reaction to changes in the immediate environment of the laundry, dishwashing or cleaning product detergent portion, for example, to changes in certain properties of the wash liquor or cleaning liquor—possible examples being the electrolyte concentration or the H⁺ ion concentration (i.e., the pH)—prevents or retards release of one or more detersive components into the wash liquor or cleaning liquor, while one or more other components of the respective laundry, dishwashing or cleaning product detergent portion or subportion have been released into the liquor. The substantive component(s) which bring(s) about prevention or retardation of the release may itself/themselves be nondetersive substances; however, a preferred embodiment of the laundry, dishwashing or cleaning product detergent portion of the invention is that wherein one or more such release preventing or retarding substantive components is/are itself/-themselves (a) detersive component(s).

Of course, combinations of the abovementioned preferred embodiments of the invention are also possible. For instance, the (physico)chemical switch(es) controlling the release of at least one detersive component may be one or more structural components or one or more substantive components or else a combination of one or more structural components with one or more substantive components of the laundry, dishwashing or cleaning product detergent portion.

Further preference is given in accordance with the invention to laundry, dishwashing or cleaning product detergent portions wherein the (physico)chemical switch(es) controlling the release of at least one detersive component is/are one or more components which, when there is a change in the electrolyte concentration in the washing or cleaning liquor, undergo a change in physical and/or chemical properties. In the context of the present invention, therefore, it is possible with preference to use a (physico)chemical switch which brings about electrolyte controlled active substance release. In the case, for example, of laundry detergents or dishwashing compositions for use in washing machines or dishwashers, the difference in the electrolyte content of the liquor of, for example, the cleaning cycle and the rinse cycle may be utilized.

One preferred embodiment of the invention therefore relates to a laundry, dishwashing or cleaning product detergent portion comprising an active substance or a combination of active detersive substances which is compounded with one or more electrolyte sensitive substances, the active substance(s) being released at a certain point in time or during a certain period of time, in the case of two or more active substances preferably at different points in time or during different periods of time, during the laundry, dishwashing or cleaning process, as a consequence of a change which occurs in the electrolyte concentration in the respective liquor.

It has in fact surprisingly been found that it is possible, for example, to release an active substance in the course of use, by compounding or coating with a material which dissolves better at low ionic strength than at high ionic strength, referred to below as “electrolyte sensitive material”, as a function of the salinity. Examples of classes of substance for consideration as electrolyte sensitive materials are the following, without the invention being restricted to these:

a) Cellulose derivatives, e.g., methylcellulose, hydroxyethylcellulose, hydroxypropylcellulose, methylhydroxyethylcellulose, carboxymethyl-cellulose with various degrees of substitution;

b) Polyvinyl alcohols with different degrees of hydrolysis and molecular weights;

c) Polyelectrolytes such as, for example, polyacrylates and, with particular preference, polystyrenesulfonate.

These electrolyte sensitive materials possess good solubility in pure water or at low ionic concentration, but become difficult to dissolve or even insoluble in the presence of higher concentrations of ions, for example, at relatively high salt concentrations. The concentration of ions per unit volume of the respective liquor, for example, the salt concentration, which is required to render insoluble the electrolyte sensitive materials or substances depends on a number of parameters, a particular example being the nature of the electrolyte sensitive material used.

In accordance with the invention, laundry, dishwashing or cleaning product detergent portions which may be used with particular advantage and are therefore further preferred are those wherein the (physico)chemical switch(es) controlling the release of at least one detersive component is/are one or more components which, when there is a change in the H+ion concentration (the pH) in the washing or cleaning liquor, undergo a change in physical and/or chemical properties.

Considering the process of machine laundering or dishwashing, the pH of the wash liquor during the wash cycle is approximately 10. The reason why this is so is that the major products available on the market for machine laundering or dishwashing contain alkali.

In the great majority of the washing machines and dishwashers that are presently available on the market, the wash processes are programmed in such a way that the wash liquor is pumped off after the main wash cycle and replaced by fresh water. In this case, independently of the temperature of the water that is passed in, there is a drop in pH by approximately 1 to 2 pH units. The precise value of the pH drop is dependent on the amount of residual liquor remaining in the machine, which is approximately 2%. It has now been found that the pH change occurring in this stage of the washing process may be utilized in order to effect targeted release of active detersive substances at certain points in time or during certain periods of time of the washing or cleaning operation.

In one particularly preferred embodiment of the invention, therefore, the laundry, dishwashing or cleaning product detergent portions comprise those (physico)chemical switches which, when there is a change in the pH of the application liquor, undergo a change in the physicochemical properties. Particular preference is given to using (physico)chemical switch substances which, as a consequence of a change in pH occurring in the application liquor, undergo a change in solubility, more preferably still exhibiting an increased solubility in water. Alternatively or in addition, preference is given to those switch substances which, when there is a change in the pH of the application liquor, undergo a change, especially a decrease, in the diffusion density and/or a change, with particular preference an acceleration, in the dissolution kinetics and/or a change, with particular preference a decrease, in the mechanical stability. Advantageous—and therefore particularly preferred—are compositions, especially detergents for machine laundering or dishwashing, which comprise a (physico)chemical switch substance which, when there is a change in pH occurring in the application liquor in the range from 11 to 6, preferably from 10 to 7, more preferably still in the range from 10 to 8, undergoes a change in its physicochemical properties and in doing so preferably has an increased solubility in water in the case of a decrease in pH in the range from 10 to 7, in particular from 10 to 8, and/or undergoes a decrease in the diffusion density and/or undergoes an acceleration of the dissolution kinetics and/or undergoes a decrease in the mechanical stability. A decrease in the diffusion density may have the effect, for example, that, when there is a change in the electrolyte concentration and/or the pH, a film or a matrix material undergoes partial dissolution and permits ingress of the aqueous liquor to the detersive formulation, or two or more such formulations, through the resultant pores, cracks or holes. Similarly, an acceleration in the dissolution kinetics as a result of the change in electrolyte concentration and/or the change in pH has the effect that a film or a matrix material dissolves more rapidly and in the case of a decrease in the mechanical stability when there is a change in the electrolyte concentration or the pH it is found that tablets comprising detersive components disintegrate more readily.

Suitable substances which may be used as such (physico)chemical switches are basic in nature and are, in particular, basic polymers and/or copolymers.

The principle of pH-dependent water solubility is based in general on a protonation or deprotonation of functional groups of the polymer molecules, with a corresponding change in their charge state as a result. The polymer, then, must be such that it dissolves in water in the charged state which is stable at a certain pH but precipitates in the uncharged state at a different pH. In the context of the present invention, it is preferred for the polymers used in accordance with the invention to have a lower water solubility at a relatively high pH than at lower pH values, or even to be insoluble in water at a relatively high pH.

Polymers with pH-dependent solubility are known in particular from pharmacy. Here, use is made, for example, of acid-insoluble polymers in order to give tablets a coating which resists gastric fluid but is soluble in the intestinal fluid. Acid-insoluble polymers of this kind are mostly based on derivatives of polyacrylic acid, which is present in undissociated and hence insoluble form in the acidic range, but is neutralized in the alkaline range, typically at a pH of 8, and goes into solution as a polyanion.

For the opposite case as well—soluble in the acidic range, insoluble in the alkaline range—there are known examples in the prior art. These substances, where the polymer molecules usually carry amino-substituted functional groups or sidechains, are used, for example, to produce tablet coatings that are soluble in gastric fluid. They generally dissolve at a pH of less than 5. Polymers where the change from soluble to insoluble occurs at a higher pH are unknown in pharmacy, since such pH values are of no physiological significance.

Suitable substances which are particularly preferred in the context of the present invention are basic (co)polymers containing amino groups or aminoalkyl groups. Comonomers may be, for example, customary acrylates, methacrylates, maleates or derivatives of these compounds. A particularly suitable aminoalkyl methacrylate copolymer is marketed by the company Rohm and carries the commercial designation/brand name Eudragit®.

Besides the thermodynamic solubility, the dissolution kinetics of a film-coated substance, or the decrease in its mechanical stability, may be of importance for the application. The dissolution kinetics of the switch substances used in accordance with the invention is pH dependent at room temperature up into the alkaline range, i.e., the films are stable for significantly longer at a pH of 10 than at a pH of 8.5, although they are thermodynamically soluble at both pH values.

In a further embodiment of the present invention, therefore, use is made of polymers whose water solubility reverses between a pH of 7 and a pH of 6 and which at relatively high pH values are less readily soluble than at lower values. As already described above, suitable polymers contain basic groups, examples being primary, secondary or tertiary amino groups, imino groups, amido groups or pyridine groups—in general, groups which possess a quaternizable nitrogen atom. When the pH is lowered, the quaternizable nitrogen atoms are protonated, and the polymer becomes soluble as a result. In relatively high pH, the molecule is in the uncharged state and is therefore insoluble. In general, the transition—referred to below as the “switching point” —takes place in the range of acidic pH values, depending on the pKb value of the basic groups and also dependent on their density along the polymer chain. The laundry, dishwashing or cleaning product detergent portions of the present invention therefore further comprise portions comprising a polymer for which the switching point is in a pH range between 6 and 7.

This shift in the switching point of a polymer suitable for the purposes of the present invention proceeds in principle as follows: depending on the pKb value of the functional groups of the polymer, there is only a very slight change in the charge state of the polymer in solution in the range of relatively high pH. Therefore, the solubility of the polymer must be able to decisively influence the solubility of the polymer with a slight change in the charge state of the polymer. In other words, the polymer must, to be exact, have a hydrophilicity such that it is insoluble in the fully uncharged state but becomes soluble when there is even a slight charging, such as by protonation, for example.

To adjust the hydrophilicity it is possible to use the following methods:

Copolymerization of a monomer having a basic function with a more hydrophilic monomer. The ratio in which the respective comonomers are incorporated influences the switching point.

Hydrophilicization of the polymer carrying basic groups by means of a polymer-analogous reaction. The degree of modification influences the switching point.

In addition to simple hydrophilicization it is also possible to introduce basic functions having different pK_{b} values. The switching point may be influenced by the ratio of the two groups and the resulting hydrophilicity of the molecule.

A particularly preferred polymer of this class of substance is an N-oxidized polyvinylpyridine.

The pH shift sensitive switches of the invention, and those used in accordance with the invention, may be employed for all applications, especially in the laundry, dishwashing or cleaning product sector, in which an active substance is to be released when there is a reduction in pH from the alkaline into the neutral range. This may be the case both in the field of laundering in the washing machine and in the case of machine dishwashing. Included in particular in accordance with the invention are detergent portions in which components of a detergent recipe for machine dishwashing (e.g., surfactants, perfume, soil repellent, acid, complexing agents, builder substances, etc., or formulations comprising these active substances) are formulated with the polymer of the invention in such a way that these components are not released into the wash liquor at high pH in the main wash cycle but are released in the subsequent rinse cycle with lower pH, where the polymer becomes soluble in water.

The polymer of pH-dependent solubility may be used either as a coating or as a matrix material, binder or disintegrant for the components intended for release at a later point in time or over a later period of time. It is not necessary in this case for the polymer to dissolve completely in order to release the active substance under the inherent pH conditions for the polymer. Rather, it is sufficient if, for example, the permeability of a polymer film changes and, for example, the penetration of water into the active substance formulation and an expulsion of the dissolved components through the holes or pores formed is made possible. By this means, in a further preferred embodiment of the laundry, dishwashing or cleaning product detergent portions of the invention, a secondary effect, e.g., the activation of an effervescent system or the swelling of a water-swellable disintegrant, which are known in particular in pharmacy, may ensure the complete release of the active detersive substance(s).

In conformity with the present invention, so-called pH shift boosters are used in addition to the abovementioned switches. By this means it is possible, at least to a predominant extent, to prevent the incidence in the application liquor after the rinse cycle of residues consisting, in particular, of the polymer substance of pH-dependent solubility itself.

Suitable pH shift boosters for the purposes of this invention are all substances and formulations which are able to increase the extent of the shift in pH (the pH shift) either locally, i.e., in the immediate environment of the particular pH shift sensitive substance, or else in a generalized way, i.e., in the wash liquor as a whole. Such substances include—to name one group of substances particularly suitable as pH shift boosters in accordance with the invention—all organic and/or inorganic, water-soluble acids or acidically reacting salts, in particular at least one substance from the group of the alkylbenzenesulfonic acids, alkylsulfuric acids, citric acid, oxalic acid and/or alkali metal hydrogen sulfates. These substances may be used alone or in a combination of two or more thereof.

The pH shift booster may be incorporated into the laundry, dishwashing or cleaning product detergent. In a further embodiment of the invention, however, it is possible to supply the pH shift booster from the outside, either after the end of the main wash cycle or at the beginning of the afterwash cycle or rinse cycle, for example, to introduce it into the corresponding filling shaft or the corresponding dosing compartment of the machine or to release it by means of a special delivery system (by coating with a slow-dissolving coating material) or by diffusion from a matrix material or enclosure material in connection with a tablet or its enclosure.

In another embodiment, the invention provides for the laundry, dishwashing or cleaning product detergent portion of the invention to comprise not only the pH shift booster but also at least two switches, of which with advantage not more than one is subject to temperature control. The use of two or more switches makes it possible for at least two switches differing in action to improve or even fine-tune the controlled release of an active detersive substance or of a combination of such active substances. Alternatively, however, it is also conceivable for two switches differing in action to bring about the controlled release of two or more different active detersive substances or combinations of different active substances at different points in time or within different periods of time of the washing or cleaning process.

In the context of this embodiment of the invention it is particularly preferred for at least two switches which are not subject to temperature control or not subject to temperature control alone to be present in the laundry, dishwashing or cleaning product detergent portion, for example, in the case of a tablet having a cavity or depression, to be present as cavity filling or depression filling. In this case it may well be of advantage if two or more (physico)chemical switches of which at least one is not subject to temperature control or not subject to temperature control alone are present in the cavity filling or depression filling.

In a very particularly preferred embodiment of the invention, one of the abovementioned (physico)chemical switches, for example, a pH shift sensitive switch or electrolyte sensitive switch, is combined with a switch which is subject to temperature control. Preference is given in this case in particular to what are known as inverse temperature switches, which may be realized by means of so-called LCST substances. LCST substances are substances which have a better solubility at low temperatures than at higher temperatures. They are also referred to as substances with a low lower critical separation temperature (low critical solubility temperature) or with a low lower turbidity point or flocculation point. Depending on application conditions, the lower critical separation temperature should lie between room temperature and the temperature of the heat treatment in the respective washing or cleaning process, for example, between 20° C. and 120° C., preferably between 30° C. and 100° C., in particular between 30° C. and 50° C. The LCST substances are selected preferably from alkylated and/or hydroxyalkylated polysaccharides, cellulose ethers, polyisopropyl-acrylamide, copolymers of polyisopropylacrylamide, and mixtures of two or more of these substances. Examples of alkylated and/or hydroxyalkylated polysaccharides are hydroxypropylmethylcellulose (HPMC), ethyl(hydroxyethyl)cellulose (EHEC), hydroxy-propylcellulose (HPC), methylcellulose (MC), ethyl-cellulose (EC), carboxymethylcellulose (CMC), carboxy-methylmethylcellulose (CMMC), hydroxybutylcellulose (HBC), hydroxybutylmethylcellulose (HBMC), hydroxy-ethylcellulose (HEC), hydroxyethylcarboxymethyl-cellulose (HECMC), hydroxyethylethylcellulose (HEEC), hydroxypropylcarboxymethylcellulose (HPCMC), hydroxy-ethylmethylcellulose (HEMC), methylhydroxyethyl-cellulose (MHEC), methylhydroxyethylpropylcellulose (MHEPC) and propylcellulose (PC).

Further examples of LCST substances are cellulose ethers and also mixtures of cellulose ethers with carboxymethylcellulose (CMC). Further polymers which exhibit a lower critical separation temperature in water and which are likewise suitable are polymers of mono- or di-N-substituted acrylamides with acrylates and/or acrylic acids, or mixtures of interpenetrating networks of the abovementioned (co)polymers. Also suitable are polyethylene oxide or copolymers thereof, such as ethylene oxide-propylene oxide copolymers, graft copolymers of alkylated acrylamides with polyethylene oxide, polymethacrylic acid, polyvinyl alcohol and copolymers thereof, polyvinyl methyl ethers, certain proteins such as poly(VATGVV), a repeating unit of the natural protein elastin and certain alginates. Mixtures of these polymers with salts or surfactants may likewise be used as LCST substance. By means of such additions or by the degree of crosslinking of the polymers it is possible to modify the lower critical separation temperature (LCST).

In a further preferred embodiment of the laundry, dishwashing or cleaning product detergent portions of the invention, a pH sensitive switch is combined with an LCST substance, it being possible in accordance with the invention for this combination to comprise a pH shift booster as well.

In accordance with another, likewise preferred embodiment of the invention, a laundry, dishwashing or cleaning product detergent portion of the present invention may also comprise other switches. Suitable, for example, are switches which are able to bring about an enzyme controlled release of active detersive substances at at least two different points in time or during at least two different periods of time. Enzyme controlled active substance release switches of this kind are described in the parallel patent application bearing the title “Detergent portion with enzyme controlled release of active substance”. Appropriate enzymes in particularly preferred embodiments of the invention are proteases, amylases, cellulases and/or lipases, whereas enzyme sensitive substances which may be used include cellulose and its derivatives, starch and its derivatives, partially oxidized starch derivatives, glycerides, proteins, and mixtures thereof. Enzyme controlled switches of this kind may be used in combination with the switches of the laundry, dishwashing or cleaning product detergent portions of the present invention.

In a further preferred embodiment, an enzyme sensitive switch is combined with an LCST substance.

In another preferred embodiment of the invention, a pH shift sensitive switch, in combination in accordance with the invention with a pH shift booster, is combined with an enzyme sensitive switch.

With particular advantage it is possible to use both a pH shift sensitive switch, in combination in accordance with the invention with a pH shift booster, and an enzyme sensitive switch and an LCST substance.

Other appropriate switches besides enzyme sensitive switches include redox switches, i.e., switches by means of which the release of active detersive substances may be brought about at at least two different points in time or during at least two different periods of time in the context of a redox reaction. Redox sensitive switches of this kind are described in the parallel patent application bearing the title “Detergent portion with redox controlled release of active substance”. In particularly preferred embodiments of the invention, suitable redox sensitive materials include oxidation sensitive organic and inorganic substances and polymers. One example of a redox sensitive material is polyvinylpyridine. Oxidizing agents used may be, for example, a percarbonate, the latter in particular in combination with a bleach activator such as TAED, for example. Switches of this kind, controlled by a redox reaction, may be used in combination with the switches of the laundry, dishwashing or cleaning product detergent portions of the present invention.

In a further advantageous embodiment of the invention, a redox sensitive switch is used together with an LCST substance and/or a pH shift sensitive switch, in combination in accordance with the invention with a pH shift booster. It is further preferred to use all three switches, i.e., a pH shift sensitive switch, a redox sensitive switch, and a switch subject to temperature control, such as an LCST substance, for example, in combination in accordance with the invention with a pH shift booster.

A further preferred embodiment of the invention provides for combining a redox sensitive switch with an enzyme sensitive switch. In addition, this combination may again include an LCST substance and/or a pH shift sensitive switch, in combination in accordance with the invention with a pH shift booster.

In another embodiment of the invention, the laundry, dishwashing or cleaning product detergent portion of the invention comprises an electrolyte sensitive switch and one or more of the aforementioned pH shift sensitive switches, in combination in accordance with the invention with a pH shift booster, an enzyme sensitive switch, a redox sensitive switch, and an LCST substance.

In one preferred embodiment of the invention, the laundry, dishwashing or cleaning product detergent portions of the invention are present in solid form, for example, as powders, granules, agglomerates, pellets, roll compacts and/or extrudates. A particularly preferred embodiment, however, is that of a shaped body constituting one laundry, dishwashing or cleaning product detergent portion, it being possible to use one or more shaped bodies per application in a washing or cleaning process. A particularly advantageous configuration is as a tablet or as a capsule. In this case it is also possible to use one or more tablets and/or one or more capsules, together if desired with powder, granules, agglomerates, pellets, roll compacts and/or extrudates. Advantageously, two or more shaped bodies or the mixtures referred to of different configurations are supplied in an enclosure such as in a pouch or in a film which either is opened prior to use, so that the laundry, dishwashing or cleaning product detergent portion may be introduced into the dosing compartment of the washing machine or dishwasher, or is soluble in water, so that it may be introduced into the machine together with the detersive formulation, without residues thereof remaining after the washing or cleaning operation. In this case, dosing both by way of the dosing compartment and by way of the detergent compartment of the respective machine is possible.

One particularly preferred embodiment is a tablet with a circular, oval or rectangular to square basal surface, which may have rounded corners and edges. The embodiment in question may comprise single-layer white or colored tablets, which preferably have different-colored speckles, or else multilayer, at least two-layer, tablets which in particular comprise at least two colors, of which one may be white.

In a further embodiment of the invention, the single-layer or multilayer shaped bodies, and especially tablets, have at least one cavity. The design of this cavity may be such that it extends from the upper surface to the lower basal surface and the shaped body, accordingly, forms a ring around a hollow space. In another preferred embodiment of the invention, the design of the cavity is such that it does not extend from the upper surface to the lower basal surface but instead merely forms a depression, which may be formed either only over one layer or else over two or more layers of the tablet. In particular, such depressions have a circular, oval or rectangular to square basal surface.

In one particularly preferred embodiment of the invention, the cavity and preferably the depression comprises one part of the overall composition of the detergent. This part of the overall composition may fill a part of the cavity or depression or the whole cavity or depression. In a preferred embodiment of the invention, one or more mixtures liquid at room temperature, which may comprise detersive components besides carriers and auxiliaries, in the form, for example, of a melt, is or are inserted in the cavity or depression. The melt solidifies on cooling.

As an alternative to this, it is also possible to prepare the cavity filling or depression filling separately and then to insert it in the cavity or depression, respectively. The cavity filling or depression filling may then be present in the cavity or depression in solid form, for example by adhesive bonding, or loose, for example in the form of a plug connection. The separately prepared cavity filling or depression filling may be prepared in a variety of ways. Preferred methods include the preparation of an uncompressed shaped body, especially a solidified melt body, or of a compressed body. In particular, the separately prepared filling bodies may adopt a shape other than that predetermined by the cavity or depression. Thus it is possible, for example, for the depression to constitute a semicircular opening in a tablet and for the filling to be present in spherical form but for the latter to have, possibly, a smaller diameter than the semicircular depression. Alternatively, it is also conceivable for the depression to have an oval basal surface, but for the filling to have a spherical form. In particular, however, it is preferred for the shaped body, including the cavity filling or depression filling, to have a planar or virtually planar surface.

In a further embodiment of the invention it is envisaged that the cavity is internal and that its filling is not visible from the outside. The actual shaped body, and especially the actual tablet, therefore, constitute a sheath which completely encloses the cavity—which in particular is filled. The cavity filling may again have been prepared in the manner already described, either separately as a melt body or compressed body, and may then have been cast or compressed to form the ultimate shaped body, or else the cavity filling is inserted in melt form into a precompressed shaped body, and this is subsequently compressed to form the ultimate shaped body.

In one particularly preferred embodiment, the invention envisages the cavity filling or depression filling comprising at least one switch for controlled active substance release which is not subject to temperature control or not to temperature control alone.

In another embodiment of the invention, the shaped body is present as a capsule. Where only parts of the overall composition are encapsulated, it is possible for the aforementioned switch systems to be incorporated into the capsule shell. For pouches, similar comments apply.

In the context of the present invention it is particularly preferred to carry out controlled release of surfactants, fragrances, dyes, bleaches, preferably an active chlorine carrier, acids, preferably citric acid, amidosulfonic acid or hydrogen sulfate, phosphonates, complexing agents, surfactants having complexing properties, builders, and cobuilders. An embodiment of the invention which is very particularly preferred in practice involves providing machine dishwashing compositions which simultaneously comprise a rinse aid which is released controllably in the rinse cycle. Particularly preferred active substances are nonionic surfactants which have a clear-rinse effect and a melting point above room temperature, i.e., above 20° C., with particular preference between 25 and 60° C., and in particular between 26.6 and 43.3° C.

Suitable nonionic surfactants having melting or softening points within the stated temperature range are, for example, low-foaming nonionic surfactants which may be solid or highly viscous at room temperature. If nonionic surfactants which are highly viscous at room temperature are used, then it is preferred that they have a viscosity above 20 Pas, preferably above 35 Pas, and in particular above 40 Pas. Also preferred are nonionic surfactants which possess a waxlike consistency at room temperature.

Preferred nonionic surfactants for use that are solid at room temperature originate from the groups of alkoxylated nonionic surfactants, especially the ethoxylated primary alcohols, and mixtures of these surfactants with surfactants of more complex construction such as polyoxypropylene/polyoxyethylene/polyoxypropylene (PO/EO/PO) surfactants. Such (PO/EO/PO) nonionic surfactants are notable, furthermore, for good foam control.

In one preferred embodiment of the present invention, the nonionic surfactant having a melting point above room temperature is an ethoxylated nonionic surfactant originating from the reaction of a monohydroxy alkanol or alkylphenol having 6 to 20 carbon atoms with preferably at least 12 mol, with particular preference at least 15 mol, in particular at least 20 mol, of ethylene oxide per mole of alcohol or alkylphenol, respectively.

A particularly preferred nonionic surfactant for use that is solid at room temperature is obtained from a straight-chain fatty alcohol having 16 to 20 carbon atoms (C₁₆₋₂₀ alcohol), preferably a C₁₈ alcohol, and at least 12 mol, preferably at least 15 mol, and in particular at least 20 mol of ethylene oxide. Of these, the so-called “narrow range ethoxylates” are particularly preferred.

Particularly preferred are C₆₋₂₀ monohydroxyalkanols or C6-20 alkylphenols or C₁₆₋₂₀ fatty alcohols with more than 12 mol, preferably more than 15 mol, and in particular more than 20 mol, of ethylene oxide per mole of alcohol.

The nonionic surfactant which is solid at room temperature preferably further possesses propylene oxide units in the molecule. Preferably, such PO units account for up to 25% by weight, with particular preference up to 20% by weight, and in particular up to 15% by weight, of the overall molecular mass of the nonionic surfactant. Particularly preferred nonionic surfactants are ethoxylated monohydroxy alkanols or alkylphenols, which additionally comprise polyoxyethylene-polyoxypropylene block copolymer units. The alcohol or alkylphenol moiety of such nonionic surfactant molecules in this case makes up preferably more than 30% by weight, with particular preference more than 50% by weight, and in particular more than 70% by weight, of the overall molecular mass of such nonionic surfactants. Preferred processes are those in which the core tablet comprises as ingredient ethoxylated and propoxylated nonionic surfactants wherein the propylene oxide units in the molecule account for up to 25% by weight, preferably up to 20% by weight, and in particular up to 15% by weight, of the overall molecular mass of the nonionic surfactant.

Further nonionic surfactants whose use is particularly preferred, with melting points above room temperature, contain from 40 to 70% of a polyoxypropylene/polyoxyethylene/polyoxypropylene block polymer blend which comprises 75% by weight of an inverted block copolymer of polyoxyethylene and polyoxypropylene containing 17 mol of ethylene oxide and 44 mol of propylene oxide and 25% by weight of a block copolymer of polyoxyethylene and polyoxypropylene, initiated with trimethylolpropane and containing 24 mol of ethylene oxide and 99 mol of propylene oxide per mole of trimethylolpropane.

Nonionic surfactants which may be used with particular preference are, for example, obtainable under the name Poly Tergent® SLF-18 from Olin Chemicals.

Further preferred are nonionic surfactants of the following formula

R¹O[CH₂CH(CH₃)O]ₓ[CH₂CH₂O]_{y}[CH₂CH(OH)R² ]

in which R¹ is a linear or branched aliphatic hydrocarbon radical having 4 to 18 carbon atoms, or mixtures thereof, R² is a linear or branched hydrocarbon radical having 2 to 26 carbon atoms, or mixtures thereof, and x is between 0.5 and 1.5, and y is at least 15.

Further nonionic surfactants which may be used with preference are the endgroup-capped poly(oxyalkylated) nonionic surfactants of the formula

R¹O[CH₂CH(R³)O]ₓ[CH₂]ₖCH(OH) [CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is between 1 and 30, k and j are between 1 and 12, preferably between 1 and 5. Where x=2, each R³ in the above formula may be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the radical R³, H, —CH₃ or —CH₂CH₃ are particularly preferred. Particularly preferred values for x lie within the range from 1 to 20, in particular from 6 to 15.

As described above, each R³ in the above formula may be different if x=2. By this means it is possible to vary the alkylene oxide unit in the square brackets. If x, for example, is 3, the radical R³ may be selected in order to form ethylene oxide (R³ =H), or propylene oxide (R³ =CH₃) units, which may be added on to one another in any sequence, examples being (EO) (PO) (EO), (EO) (EO) (PO), (EO) (EO) (EO), (PO)(EO)(PQ), (PO)(PO)(EO) and (PO) (PO) (PO) . The value of 3 for x has been chosen by way of example in this case and it is entirely possible for it to be larger, the scope for variation increasing as the values of x go up and embracing, for example, a large number of (EO) groups, combined with a small number of (PO) groups, or vice versa.

Particularly preferred endgroup-capped poly(oxy-alkylated) alcohols of the above formula have values of k=1 and j=1, thereby simplifying the above formula to

R¹O[CH₂CH(R³)O]ₓCH₂CH(OH)CH₂OR².

In the last-mentioned formula, R¹, R² and R³ are as defined above and x stands for numbers from 1 to 30, preferably from 1 to 20, and in particular from 6 to 18. Particular preference is given to surfactants wherein the radicals RI and R2 have 9 to 14 carbon atoms, R³ is H, and x adopts values from 6 to 15.

Summarizing the last-mentioned statements, preference is given to endgroup-capped poly(oxyalkylated) nonionic surfactants of the formula

R¹O[CH₂CH(R³)O]ₓ[CH₂]ₖCH(OH) [CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is between 1 and 30, k and j are between 1 and 12, preferably between 1 and 5, particular preference being given to surfactants of the type

R¹O[CH₂CH (R³)O]ₓCH₂CH (OH) CH₂OR²

where x is from 1 to 30, preferably from 1 to 20, and in particular from 6 to 18.

In one preferred embodiment of the invention, cavity fillings or depression fillings are used which comprise a nonionic surfactant or a surfactant mixture with clear-rinse effect in amounts of from 20 to 50% by weight, one or more (physico)chemical switches, in combination if desired with a temperature sensitive switch in amounts of from 40 to 70% by weight and, optionally, a pH shift booster in amounts of from 2 to 15% by weight, in particular in amounts of up to 10% by weight, the percentages by weight being based on the fillings.

Otherwise, the—in particular, solid—laundry, dishwashing or cleaning product detergent portions may comprise conventional ingredients in conventional amounts. Here, reference is made to the relevant technical literature and to the detailed description above. In particular, it is preferred to equip the laundry, dishwashing or cleaning product detergent portions of the invention with a conventional effervescent system, comprising carbonate and citric acid, for example, in which context it may be particularly preferred for the cavity filling or depression filling as well to have such an effervescent system. This effervescent system may be activated by a change in the water permeability of the coating with the material of the (physico)chemical switch as a result of the change in the respective relevant parameter during the washing or cleaning operation. Alternatively to an effervescent system it is also possible to use a disintegrant known, for example, from pharmacy or from laundry detergent technology.

The following are suitable for use in textile laundry detergents with release at a certain point in time in the wash process, e.g., in the rinse cycles:

Textile hand components, enzymes, alkalis, acids, fragrances, dyes, fluorescers, optical brighteners, shrinkage preventatives, anticrease agents, active antimicrobial substances, germicides, fungicides, antioxidants, antistats, easy-iron auxiliaries, repellents, impregnating agents, UV absorbers, and any desired mixtures of the aforementioned detersive components.

Especially in the case of solid machine dishwashing compositions, the present invention may be utilized in order to transport active substances through the main wash cycle into the rinse cycle. In this case, a formulation comprising, for example, rinse aid surfactant or else other of the abovementioned active ingredients may be coated with an electrolyte sensitive material and/or a pH shift sensitive material or may be incorporated into a matrix comprising an electrolyte sensitive material and/or pH shift sensitive material. This formulation is subsequently formulated together with the customary detersive component(s), e.g., added to a powder cleaner or combined with a shaped body. As for the pH shift sensitive switch, it is not absolutely necessary for the electrolyte sensitive material to dissolve completely under the corresponding electrolyte or pH conditions in the rinse cycle in order to release the active detersive substance. Rather, it is sufficient for there to be a change in the permeability of the electrolyte or pH shift sensitive film or of the corresponding matrix and, for example, for the penetration of water into the active substance formulation to be made possible. As a result, a secondary effect, for example, the activation of an effervescent system, may ensure the complete release of the active substance.

In a particularly preferred embodiment of the invention, laundry, dishwashing or cleaning product detergent formulations are provided with two or more detersive components, in which components for release into the respective liquor at a later stage of the washing or cleaning process, such as, for example, rinse aid surfactants, acids (such as citric acid, for example), fragrances, soil repellents, enzymes, catalysts, bleaches, etc., in compositions for machine dishwashing are provided with a pH shift sensitive coating, are compounded into a detersive formulation using a pH shift sensitive binder, or are compounded into a detersive formulation using a pH shift sensitive matrix material. The resulting coated or compounded product further comprises other customary detersive components of laundry, dishwashing or cleaning product detergent portions, as have been described in detail above.

Setting the switching point to a pH which can be used for practical purposes of from 10 to 8, very particularly from 10 to 8.5, is done by copolymerizing conventional basic monomers of the general formula (A)

H₂C═C (—R)COO(CH₂)ₓN(R¹) (R²) (A)

where R is H or CH₃, R¹ and R² independently of one another are alkyl radicals having 1 to 3 carbon atoms, and x is an integer from 1 to 4, as repeating units with a hydrophobic monomer which is insoluble or sparingly soluble in water, of the general formula (B)

H₂C═C (—R³)—(CH₂)_{y}—B—R⁴ (B)

where R³ is H, CH₃ or COOH, R⁴ is a straight-chain or branched alkyl radical having 1 to 8 carbon atoms, B is C(O)O or OC(O), and y is 0 or 1, and a water-soluble monomer of the general formula (C)

H₂C═C(—R⁵)—C(O)—R⁶ (C)

where R⁵ is H or CH₃ and R⁶ is an amino group which is unsubstituted or substituted, for example, with an N,N-dimethylaminopropyl group or is a hydroxyalkyl group having 1 to 3 carbon atoms in the alkylene radical or is a polyethylene glycol radical, it being possible to adjust the solubility of the copolymer by way of the molar ratio of the abovementioned monomer units. Preferred compounds of the general formula (A) are, for example, N,N-dimethylaminoethyl (meth)acrylate and N,N-dimethylaminopropyl (meth)acrylate. Preferred compounds of the above general formula (B) include, for example, (meth)acrylic esters having preferably 1 to 8 carbon atoms, vinyl acetate or alkyl itaconates having 1 to 8 carbon atoms in the alkyl radical. Suitable compounds of the general formula (C) include N,N-dimethyl-aminopropyl(meth)acrylamide, 2-hydroxyethyl (meth)-acrylate or (meth)acrylic esters of polyethylene glycols. The ratio of the repeating units (A):(B):(C) to the sum of the three components is in the range from [from 0.1 to 0.7]:[from 0.05 to 0.6]:[from 0.1 to 0.7], based on [(A)+(B)+(C)].

Using a pH shift sensitive copolymer of this kind it is possible to coat, compound or embed detersive components whose release into the liquor is desired not until a relatively late point in time in the washing or cleaning process. As a result, the detersive substances thus treated are released only in a relatively late process step, when the pH of the application liquor has dropped from >10 to <8.5 or below and the copolymer has become soluble owing to the shift in pH.

Said active detersive substances may be compounded conventionally. By way of example, mention may be made of the following procedures: the active substance(s) may be adsorbed onto an appropriate carrier material. Examples of the carriers are highly porous substances from different classes of substance, such as highly disperse silica, for example; zeolites (e.g., Wessalith types such as P or XD), porous polymer gels such as the commercial product with the designation Polypore E200 (from Chemdal Corp.; allyl methacrylate crosspolymer); template structures such as highly porous silicatic substances obtained by ceramicization of surfactant associates, or bentonite. The carrier/active substance ratio may be, preferably, in the range from 3:1 to 1:5, based on the weight. The product should retain a free-flowing, granular structure, it being possible to effect subsequent compression, in which case the pH shift sensitive copolymer may be incorporated as a binder or applied as a coating.

In other preferred embodiments of the invention, the substance(s) intended for later release in the washing or cleaning process such as, for example—without, however, restricting the invention—a rinse aid in a composition for machine dishwashing, may be compounded with an appropriate polymer in such a way that the resultant formulation may be extruded. Appropriate polymers for these purposes are, for example, partially hydrolyzed polyvinyl alcohols (PVALs) and fully hydrolyzed polyvinyl alcohol (PVALs) with the addition of polyvinyl acetate (PVAc) or polyethylene glycol (PEG). The resultant extrudate is subsequently provided coatingswise with a coating comprising, for example, a pH shift sensitive component, e.g., a pH shift sensitive polymer.

In another embodiment of the invention, the substance(s) intended for later release in the washing process is/are incorporated, alone or else together with one or more other detersive substances, into a capsule made from a water-soluble polymer such as, for example, gelatin. A filled gelatin capsule of this kind is then provided with the coating comprising, for example, a pH shift sensitive component such as, for example, a pH shift sensitive polymer.

In order to ensure that the pH shift sensitive coating does not dissolve in the earlier steps of the washing or cleaning operation, for example, at the beginning of the main wash cycle in the case of machine dishwashing, when fresh water is passed in but the laundry, dishwashing or cleaning product detergent subportions intended for the cycle in question have not yet fully released their alkaline components into the application liquor in order to establish a high (alkaline) pH, various techniques may be employed, in order to avoid losses of active substances:

(a) The coating may be made sufficiently thick or the molecular weight of the polymer sufficiently high. In accordance with the invention, the coat thickness is in the range from 5 μm to 50 μm, but in order to avoid active substance losses is preferably adjusted to a range from 20 μm to 40 mm. In accordance with the invention, the molecular weight of the polymer coating should be at least 50 kD, preferably at least 1 000 kD. Combinations of both parameters are possible and are particularly preferred.

An active substance loss may also be avoidable by admixing to the coating material a further polymer which lowers the solubility of the blend. Examples of such additional polymers are, in general, those which are less hydrophilic/more hydrophobic than the coating polymer.

(b) In accordance with the invention, it is also possible to coat a coat which is sensitive to a pH shift from 10 to pH values lying further in the acidic range by applying a further pH shift sensitive coat which only dissolves when the pH of the aqueous liquor used for the wash cycle has risen to 10.

In accordance with a similar principle, an additional coat which dissolves less rapidly or less effectively at a relatively low temperature may also be applied. This may be, for example, a paraffin which melts on reaching a relatively high temperature (which is traversed only in the subsequent step) (“melt coating”), or else a hydrophilic polymer which becomes soluble on reaching a certain temperature (“polymer coating”).

(c) The formulation comprising the substance(s) intended for later release in the washing or cleaning process may be incorporated in its entirety into the formulation comprising the other components of the laundry, dishwashing or cleaning product detergent portion, this latter formulation being present, for example, in the form of a tablet, so that the substance(s) intended for later release in the washing or cleaning process come into contact with the liquor or with the fresh water only when the components used earlier have already been drawn off with the liquor.

In accordance with a further embodiment of the invention, electrolyte sensitive switches, for example, electrolyte sensitive polymer coats, may be optimized by adding to them further components which bring about not only an improvement in the behavior of the coat following application to detersive formulations but also improved release characteristics of said formulations at the desired point in time of the washing or cleaning cycle. Electrolyte sensitive polymers of this embodiment of the invention may be, for example, polyvinyl alcohols with different degrees of hydrolysis (i.e., polyvinyl alcohols having different residual vinyl acetate group contents); the degrees of hydrolysis are in the range from 70 to 98 mol % (residual vinyl acetate groups: 30 to 2 mol %). The polymers are mixed with one or more auxiliaries from the pigments, lubricants group. The amount of said auxiliaries is in the range from 1 to 40% by weight, based on the sum of all such auxiliaries present; in the case of two or more of them, the weight ratio of the individual auxiliaries to one another is not critical, but may be in the range from 5:1 to 1:5. A preferred example of such auxiliaries is talc. In a particularly preferred embodiment of the invention it is also possible to incorporate detersive components into such a coating composition (coating). With advantage it is possible for this purpose to use, for example, plasticizers, pearlescence agents, color pigments, dyes, perfume oils, aroma substances and/or fragrances, and other detersive substances, as recited in detail above.

Such polymers are applied in coating thicknesses in the range from 10 to 500 μm, preferably in the range from 100 to 350 μm, with further preference in the range from 150 to 300 μm, to the detersive formulations intended for release later in the washing or cleaning process: for example, to shaped bodies of such formulations, to granules of such formulations, to particles of such formulations, or to portions which have been filled into enclosures, such as capsules or pouches, for example. Said polymer/auxiliary mixtures are preferably applied to shaped bodies or capsules, in order to permit controlled release of individual detersive components or mixtures of such components from these bodies or capsules into the respective application liquor. It will be understood that—as is further preferred—such coatings may be produced not only (or not solely) with electrolyte sensitive components but also with other components (for example, heat sensitive, pH shift sensitive, enzyme sensitive and/or redox sensitive components). In the same way it is possible to combine an electrolyte sensitive coating of composition as described above with one or more separate, different coat(s) (for example, heat, pH shift, enzyme and/or redox sensitive coat(s)) in any desired combination and sequence.

The aforementioned materials may be used not only as coatings for detersive formulations in capsules or in the form of shaped bodies (granules, tablets, etc.) but also for fixing in recesses of shaped bodies (e.g., depression tabs, ring tabs, etc.) or else in water-soluble polymer pouches, together with other components of detersive formulations.

The invention also relates to a process for producing the laundry, dishwashing or cleaning product detergent portions described in detail above, preferably those comprising two or more detersive components of which at least two are to be released into the liquor at different points in time or in two different periods of time in a washing or cleaning operation. In accordance with the invention, the detersive component(s) to be released into the liquor at a later point in time in the washing or cleaning operation is/are compounded with a release controlling (physico)chemical switch and with one or more substances for increasing the extent of the shift in pH (preferably, the pH shift booster) and the detersive component(s) thus compounded is/are processed with one or more other detersive components to form a laundry, dishwashing or cleaning product detergent portion.

In one preferred procedure in accordance with the invention, the (physico)chemical switch(es) controlling the release of at least one detersive component is/are chosen to comprise one or more structural or substantive components of a laundry, dishwashing or cleaning product detergent portion. Appropriate structural and substantive components of the laundry, dishwashing or cleaning product detergent portion have been described in detail above.

Further preferred in accordance with the invention is a process wherein the (physico)chemical switch(es) controlling the release of at least one detersive component is/are chosen to comprise one or more components which, when there is a change in the electrolyte concentration in the wash liquor or cleaning liquor, undergo a change in the physical and/or chemical properties. With particular advantage, and therefore very particularly preferred, is a process wherein the (physico)chemical switch(es) controlling the release of at least one detersive component is/are chosen to comprise one or more components which, when there is a change in the H⁺ ion concentration (the pH) in the wash liquor or cleaning liquor, undergo a change in the physical and/or chemical properties.

In a procedure which may be employed with particular advantage, the (physico)chemical switch chosen comprises one or more substances which, when there is a change in the electrolyte concentration, preferably a change in the pH, in the wash liquor or cleaning liquor,

(a) undergo a change in solubility in water; and/or

(b) undergo a change in diffusion density; and/or

(c) undergo a change in dissolution kinetics; and/or

(d) undergo a change in mechanical stability.

More preferably still, the change in pH is a change of the pH in the wash liquor or cleaning liquor in the range from 11 to 6, preferably in the range from 10 to 7, more preferably a decrease in the pH in the range between 10 and 8. Further preference is given to procedures using as (physico)chemical switches one or more substances which in the case of said changes in pH, preferably in the case of said decrease in pH,

(a) undergo an increase in solubility in water; and/or

(b) undergo a decrease in diffusion density; and/or

(c) undergo an acceleration in dissolution kinetics; and/or

(d) undergo a decrease in mechanical stability.

As already described above, the (physico)chemical switch used comprises one or more substances from the group consisting of basic polymers and/or copolymers, preferably basic polymers and/or copolymers containing amino groups and/or aminoalkyl groups, imino groups and/or pyridine groups, more preferably still an aminoalkyl methacrylate copolymer.

Ultimately, the invention also relates to a washing process, especially a washing process in a washing machine, in which a laundry detergent portion as described in detail above is brought into contact with laundry, being inserted in particular into the detergent compartment of a commercially customary washing machine, and is rinsed into the wash liquor with water of the first wash cycle, the early steps of the wash operation are conducted as normal and then conditions are established under which the release controlling (physico)chemical switch(es), which is/are not subject or not subject exclusively to temperature control, releases/release into the wash liquor the component(s) intended for later release into the wash liquor.

Furthermore, the invention also relates to a washing process, especially a washing process in a dishwashing machine, in which a dishwashing detergent portion as described in detail above is brought into contact with ware, being inserted in particular into the detergent compartment of a commercially customary dishwashing machine, and is rinsed into the wash liquor with water of the first wash cycle, the early steps of the wash operation are conducted as normal and then conditions are established under which the release controlling (physico)chemical switch(es), which is/are not subject or not subject exclusively to temperature control, releases/release into the wash liquor the component(s) intended for later release into the wash liquor.

Finally, the invention also relates to a cleaning process, in which a cleaning product detergent portion as described in detail above is brought into contact with material to be cleaned, the early steps of the cleaning operation are conducted as normal and then conditions are established under which the release controlling (physico)chemical switch(es), which is/are not subject or not subject exclusively to temperature control, releases/release into the cleaning liquor the component(s) intended for later release into the cleaning liquor.

The invention is illustrated by the following examples, but without being restricted to these examples, which represent preferred embodiments of the invention.

### EXAMPLES

### Example 1

A mixture of 60% by weight aminoalkyl methacrylate copolymer (Eudragit E®, Röhm) and 40% by weight of a nonionic surfactant (Poly Tergent SLF 18 B®, Olin Chemicals) was prepared with heating and the homogenous composition formed was poured into the three-dimensional recess, configured in the form of a depression, of a conventionally produced detergent tablet. Following solidification, the filled-depression tablets thus obtained underwent a 65° C. wash program in a commercially customary dishwasher from Bosch, the tablets being introduced by way of the dosing compartment. Following the end of the wash program, the depression filling was still virtually undissolved, but at the end of the rinse cycle had very substantially dissolved. A distinct rinse-clean effect was obtained.

### Example 2

Tablets and capsules were prepared with an effective amount of rinse aid surfactant (500 mg of Poly Tergent SLF® 18B45) . The product was subsequently film coated with aminoalkyl methacrylate copolymer (Eudragit E®). The tablets and capsules thus produced underwent a 65° C. wash program as in Example 1 together with a commercially customary tableted machine ware cleaner (Somat Profi®) as in Example 1. After the wash cycle, the coated tablets and capsules containing rinse aid were virtually undissolved. After the rinse cycle, the tablets and capsules had very largely dissolved, the discernible residues consisting predominantly of coating material. A distinct clear-rinse effect on kitchen- and tableware was found.

### Example 3

Example 1 was repeated. However, in this case the depression filling used was 57.5% by weight Eudragit E®, 37.5% by weight Poly Tergent SLF® 18 B, and 5% by weight alkylbenzenesulfonic acid, and was poured into the depression of the detergent tablets in the form of a melted homogenous composition. Following solidification, the wash program was conducted in a dishwasher as described above. After the end of the wash cycle, the depression filling remained virtually undissolved. At the end of the rinse cycle, the depression filling was very substantially dissolved. Significantly little to no residues were found in the dishwasher. A distinct clear-rinse effect on kitchen- and tableware was found.

### Example 4

In accordance with Example 2 above, coated tablets or capsules were produced which contained additionally 5% by weight of different acids (alkylbenzenesulfonic acid and/or oxalic acid). While the clear-rinse effects were comparable with the results of Example 2, very substantial dissolution of the tablets or capsules was found after the rinse cycle. Residues were either absent or minimal, but in any case significantly lower than in Example 2.

### Example 5

Examples 1 and 2 were repeated; the pH shift booster, citric acid (2.5 g), was either supplied externally after the end of the wash cycle and/or at the beginning of the rinse cycle, or released by means of a specific delivery system (by coating with a slow-dissolving coating agent). This allowed residues to be minimized.

### Example 6

### Preparation of Polymers Having a Switching Point in the pH Range Between 6 and 7

As an example of a pH shift switching polymer whose switching point is in the pH range between 6 and 7, polyvinylpyridine with an average molecular mass Mₙ=90 000, partially converted to the N-oxide, was synthesized. The synthesis is in accordance with the following examples:

Initial introduction of polyvinylpyridine (PVPy) In a four-necked flask with KPG stirrer, thermometer, reflux condenser and N₂ blanketing, 105.3 g of 4-vinylpyridine were dissolved in 210 ml of methanol at 150 rpm under the N₂ atmosphere. Azobis(isobutyro-nitrile) AIBN (1.05 g) dissolved under reflux at 65° C. in 105 ml of methanol was perfused over the course of 3 h. Polymerization took place at 65° C. over a period of 10 h. The polyvinylpyridine (PVPy) was precipitated from ethyl acetate. The yield was 90%.

### Example 6.1

In a 500 ml four-necked flask with KPG stirrer, thermometer and reflux condenser, 2.5 g of PVPy were dissolved in 25 g of glacial acetic acid at 60° C. with stirring. 1 drop of concentrated H₂SO₄ and 3.2 g of 30% strength H₂O₂ were dissolved in 12.5 g of glacial acetic acid and this solution was added dropwise at 25° C. with stirring to the first solution. This was followed by stirring at 25° C. for 30 minutes and then by heating to 80 to 85° C. At this temperature, full oxidation took place within 6 h. Since H₂O₂ was used in excess, the peroxide content was >25 mg/l.

### Example 6.2

Oxidation was carried out as in Ex. 6.1. At 60% oxidation, the H₂O₂ content was reduced to 1.6 g. Oxidation was quantitative. The peroxide content was <5 mg/l.

### Example 6.3

Oxidation was carried out as in Ex. 6.1. At 30% oxidation, the H₂O₂ content was reduced correspondingly to 0.8 g. Oxidation was quantitative. The peroxide content was <1 mg/l.

The corresponding procedure was carried out using the polyvinylpyridine N-oxides having a degree of oxidation of 48%, 50%, 51%, 52%, and 53%.

The pH dependent solubility of all PVPy N-oxides prepared was initially detected without workup and separation of the acetate. Following complete conversion, a sample of each batch was diluted with water and titrated with concentrated sodium hydroxide solution. The initial pH at which the solution was completely clear was approximately 3. The pure substance was obtained by dialyzing the aqueous polymer solution after separating off the water.

In Table 1 below, the pH at which the 10% strength by weight polymer solution underwent marked clouding and flocculation during the titration with iN NaOH at room temperature is stated as a function of the degree of oxidation of the polyvinylpyridine before and after dialysis.

It was observed that the switching point may be shifted into the neutral range by oxidation. After that point, the hydrophilicity of the polymer had increased so greatly that it was soluble at virtually any pH.

TABLE 1

| Degree of | PVPy N-oxide, not | PVPy N-oxide |
|---|---|---|
| oxidation | worked up, clouding | after dialysis |
| PVPy [%] | [pH clouding] | [pH clouding] |
| 0 | 4.8 | 4.8 |
| 30 | 5.0 | — |
| 48 | 6.6 | 5.9 |
| 50 | 6.4-7.0 | 6.5 |
| 51 | 6.4-7.2 | 6.5 |
| 52 | 6.4-7.8 | 6.5 |
| 53 | 12 | 12 |
| 60 | >12 | — |
| 100 | Soluble at any pH | Soluble at any pH |

However, as already mentioned, the dissolution kinetics are more important than the solubility for the purpose of practical application as a pH switch. The following example shows that these kinetics retain a marked pH sensitivity even at substantially higher pH values.

### Example 6.4

To investigate the dissolution kinetics of PVPy N-oxide films as a function of pH, the PVPy N-oxide with a degree of oxidation of 51% was filmed.

Preparing the polymer films:

For filming, an aqueous solution of the dialyzed PVPy N-oxide with the composition 26% by weight PVPy N-oxide, 0.1% by weight Perenol S5 additive and 0.5% by weight Cibacron Brilliant Red dye was used. Using a knife coater, the solution was applied to glass plates to give films 150 μm thick. The plates were subsequently dried at RT for 12 h before being placed in aqueous solutions whose pH had been adjusted to 10 and 8.5 using sodium carbonate. At a pH of 10, the polymer film was fully dissolved after 21 minutes, at a pH of 8.5 after just 12 minutes.

This effect was utilized in order to transport a formulation component, containing rinse aid, of a machine dishwashing composition through the main wash cycle into the rinse cycle. For this purpose, a rinse aid surfactant (Poly Tergent SLF 18B) was applied to a carrier material and coated with a film of partly oxidized polyvinylpyridine. The thickness of the film was adjusted such that the film dissolved only partly in the main wash cycle at high pH but became detached in the rinse cycle at a lower pH and thus released the rinse aid.

### Example 7

Example 1 was repeated. However, in this case the depression filling used was 46.8% by weight Eudragit E®, 31.3% by weight Poly Tergent SLF® 18 B, 7.8% by weight alkylbenzenesulfonic acid and 14.1% by weight methylcellulose, and was poured into the depression of the detergent tablets in the form of a melted homogeneous composition. Following solidi-fication, the wash program was conducted in a dishwasher as described above. After the end of the wash cycle, the depression filling remained virtually undissolved. At the end of the rinse cycle, the depression filling was very substantially dissolved and with virtually no residue.

### Example 8

As in Example 2 above, coated tablets or capsules were produced which contained an effective amount of rinse aid surfactant (500 mg of Poly Tergent SLF® 18B45) These products were subsequently film coated with aminoalkyl methacrylate copolymer. Amylose in an amount of 10% by weight, based on the overall coating material, was dispersed in the coating material as a finely powdered solid. The products were tested as in Example 2.

After the wash cycle, the coated tablets and capsules were undissolved. At the points where there were amylose domains in the coating material, small holes were discernible.

After the rinse cycle, the tablets and capsules were fully dissolved. This was evidently achieved by the combination of the two control mechanisms.

### Example 9

Rinse aid surfactant (Poly Tergent SLF® 18B) was applied to a carrier material and coated with a film of polystyrenesulfonate (Mw=1 000 000) or polyvinyl alcohol or methylcellulose. The coat thickness was adjusted such that the film dissolved only partly in the main wash cycle, owing to the high electrolyte concentration prevailing there, as a result of the ionic constituents of the cleaner, but detached in the presence of clean water and so released the rinse aid surfactant.

Example 10

18 parts by weight of PolyPore, 10 parts by weight of PEG 6000 and 72 parts by weight of Poly Tergent (rinse aid surfactant), based in each case on 100 parts by weight of the overall mixture, were kneaded to form a homogeneous mixture which was subsequently shaped to form beads having a mass of 1 g.

The beads were dip-coated with a pH shift sensitive copolymer of N,N-dimethylaminoethyl methacrylate (DMAEMA), methyl methacrylate (MMA), N,N-dimethylamino-propylmethacrylamide (DMAPMAm) and hydroxyethyl methacrylate (HEMA) in a molar ratio of 35:25:30:10 as a 30% (w/w) formulation in acetone/isopropanol (40:60; v/v) and had been further colored with a dye, and then were dried at 40° C. for 30 minutes. The coating step was repeated.

The pH dependent solubility of the coating was tested in the pH range from 10 to 8.5, which is relevant for practical use, using two buffer solutions having a pH of 10 and 8.5. For this purpose, one coated bead with the rinse aid surfactant was placed in a wire mesh basket which was immersed into the respective buffer solution. The solution was stirred at 700 rpm. The point in time at which the pH shift sensitive coating dissolved was recorded. The results are reported in Table 2 below.

TABLE 2

| Time | | | pH 10 at |
|---|---|---|---|
| [min] | pH 8.5 at RT | pH 10 at RT | 55° C. |
| 10 | Bead decolors; | No change. | Swelling of |
| | solution takes on | | the coating |
| | color of the | | |
| | coating. | | |
| 20 | Coating dissolves; | No change. | No change. |
| | solution becomes | | |
| | milkily cloudy. | | |
| 60 | Bead dissolves | No change. | No change. |
| | slowly; solution | | |
| | becomes very cloudy. | | |
| 95 | Bead has dissolved. | Experiment | Experiment |
| | | terminated: coating | terminated; |
| | | has swollen but has | bead |
| | | not dissolved from | remains |
| | | the bead. | stable. |

### Example 11

The following coating recipes were prepared:

(a) Polyvinyl alcohol (degree of hydrolysis approximately 70%; product Erkol M05/280 from Erkol S.A.); 10% strength aqueous solution;

(b) Polyvinyl alcohol (degree of hydrolysis approximately 98%; product Erkol M05/20 from Erkol S.A.); 15% strength aqueous solution;

(c) Polyvinyl alcohol (degree of hydrolysis approximately 98%; product Erkol M05/20 from Erkol S.A.); 15% strength aqueous solution; and 40% by weight talc, based on the PVAL dry weight.

Soft gelatin capsules as used for enclosing detersive components (weight approximately 0.8 g; filling volume: 0.5 g) were coated in a fluidized bed in a coating vessel with the aforementioned coatings (a) to (c).

A film which would have been sufficiently thick and defect-free could not be applied to the capsules using coatings (a) and (b). During the process of applying the coating, the capsules stuck to one another, so likewise disrupting the uniformity of the coating.

The recipe (c) was applied to the capsules as a film without problems. 0.05 g of coating (coating thickness approximately 150 μm), 0.08 g of coating (coating thickness approximately 240 μm) and 0.11 g of coating (coating thickness approximately 350 μm) were applied per gelatin capsule.

3 each of the gelatin capsules thus coated were supplied to a dishwasher (Bosch S712) by way of the dosing flap together with a conventional detergent depression tab. The results can be seen from Table 3 below. As the table reveals in detail, it was possible using the combination of PVAL (degree of hydrolysis: 98%) and talc to produce electrolyte sensitive coatings for capsules filled with dishwashing components (rinse aid) which do not dissolve in the (electrolyte rich) wash medium of the main wash cycle and so prevent release of the rinse aid surfactant in this cycle. Only in the low electrolyte water of the rinse cycle is the coating of the capsules dissolved, and then permits dissolution of the gelatin capsule and thus release of the rinse aid surfactant into the wash liquor.

TABLE 3

| Coating | | | |
|---|---|---|---|
| weight | | 50° program | 65° program |
| 0.05 | g | Capsules do not dissolve | Capsules dissolve in the |
| | | in the main wash cycle | main wash cycle. |
| | | but do dissolve | |
| | | (completely) in the | |
| | | rinse cycle. | |
| 0.08 | g | Capsules do not dissolve | Capsules dissolve in |
| | | in the main wash cycle | part in the main wash |
| | | but do dissolve | cycle (residues of the |
| | | (completely) in the | coating after main wash |
| | | rinse cycle, | cycle) . There are no |
| | | | longer any coating |
| | | | residues after the rinse |
| | | | cycle. |
| 0.11 | g | Capsules do not dissolve | Capsules do not dissolve |
| | | in the main wash cycle | in the main wash cycle |
| | | but do dissolve | but do dissolve |
| | | (completely) in the | (completely) in the |
| | | rinse cycle. | rinse cycle. |

What is claimed is:

1. A laundry, dishwashing or cleaning product detergent portion having two or more detersive components of which at least two are to be released into the liquor at different points in time in a laundering, dishwashing or cleaning process, said portion comprising at least one release controlling (physico)chemical switch which is not subject or not exclusively subject to temperature control, and also one or more substances for increasing the extent of the shift in pH.

2. The detergent portion as claimed in claim 1, wherein the (physico)chemical switche(s) controlling the release of at least one detersive component is/are one or more structural or substantive components of the detergent portion.

3. The detergent portion as claimed in claim 1 or claim 2, in which the (physico)chemical switch(es) controlling the release of at least one detersive component is(are) one or more components, when there is a change in the electrolyte concentration in the wash or cleaning liquor, undergo a change in physical and/or chemical properties.

4. The detergent portion as claimed in any one of claims 1 to 3, in which the (physico)chemical switch(es) controlling the release of at least one detersive component is(are) one or more components, when there is a change in the H+ion concentration (the pH) in the wash or cleaning liquor, undergo a change in physical and/or chemical properties.

5. The detergent portion as claimed in any one of claims 1 to 4, comprising as (physico)chemical switch(es) one or more substances which, when there is a change in the electrolyte concentration, preferably a change in the pH, in the wash liquor or cleaning liquor,
(a) undergo a change in solubility in water; and/or
(b) undergo a change in diffusion density; and/or
(c) undergo a change in dissolution kinetics; and/or
(d) undergo a change in mechanical stability.

6. The detergent portion as claimed in any one of claims 1 to 5, comprising as (physico)chemical switch(es) one or more substances which, when there is a change in the pH in the wash liquor or cleaning liquor in the range from 11 to 6, preferably in the range from 10 to 7, more preferably a decrease in the pH in the range between 10 and 8,
(a) undergo a change in solubility in water; and/or
(b) undergo a change in diffusion density; and/or
(c) undergo a change in dissolution kinetics; and/or
(d) undergo a change in mechanical stability; preferably
(a) undergo an increase in solubility in water; and/or
(b) undergo a decrease in diffusion density; and/or
(c) undergo an acceleration in dissolution kinetics; and/or
(d) undergo a decrease in mechanical stability.

7. The detergent portion as claimed in any one of claims 1 to 6, comprising as (physico)chemical switch(es) one or more substances from the group consisting of basic polymers and/or copolymers, preferably basic polymers and/or copolymers containing amino groups and/or aminoalkyl groups, imino groups and/or pyridine groups, more preferably still an aminoalkyl methacrylate copolymer.

8. The detergent portion as claimed in any one of claims 1 to 7, comprising not only the (physico)chemical switch but also a pH shift booster.

9. The detergent portion as claimed in any one of claims 1 to 8, comprising as pH shift booster one or more substances from the group consisting of organic and inorganic, water-soluble acids and acidically reacting salts, preferably one or more substances from the group consisting of alkylbenzenesulfonic acids, alkylsulfuric acids, citric acid, oxalic acid, and alkali metal hydrogen sulfates.

10. The detergent portion as claimed in any one of claims 1 to 9, comprising at least two switches of which preferably not more than one is subject to temperature control.

11. The detergent portion as claimed in any one of claims 1 to 10, comprising a pH sensitive switch and/or an electrolyte sensitive switch in combination with a switch subject to temperature control or a pH sensitive switch and/or an enzyme sensitive switch in combination with a switch subject to temperature control or a pH sensitive switch and/or a redox switch in combination with a switch subject to temperature control.

12. A process for producing a laundry, dishwashing or cleaning product detergent portion having two or more detersive components of which at least two are to be released into the liquor at different points in time in a washing or cleaning process, which comprises compounding the detersive component(s) for release into the liquor at a later point in time in the washing or cleaning process with a release controlling (physico)-chemical switch and also with one or more substances for increasing the extent of the shift in pH, and processing the detersive component(s) thus compounded with one or more other detersive components to give a laundry, dishwashing or cleaning product detergent portion.

13. The process as claimed in claim 12, wherein the (physico)chemical switch(es) controlling the release of at least one detersive component is/are chosen to comprise one or more structural or substantive components of a laundry, dishwashing or cleaning product detergent portion.

14. The process as claimed in claim 12 or claim 13, in which the (physico)chemical switch(es) controlling the release of at least one detersive component is/are chosen to comprise one or more components which, when there is a change in the electrolyte concentration in the wash liquor or cleaning liquor, undergo a change in physical and/or chemical properties.

15. The process as claimed in any one of claims 12 to 14, in which the (physico)chemical switch(es) controlling the release of at least one detersive component is/are chosen to comprise one or more components which, when there is a change in the H⁺ ion concentration (the pH) in the wash liquor or cleaning liquor, undergo a change in physical and/or chemical properties.

16. The process as claimed in any one of claims 12 to 15, in which the (physico)chemical switch(es) is/are chosen to comprise one or more substances which, when there is a change in the electrolyte concentration, preferably a change in the pH, in the wash liquor or cleaning liquor,
(a) undergo a change in solubility in water; and/or
(b) undergo a change in diffusion density; and/or
(c) undergo a change in dissolution kinetics; and/or
(d) undergo a change in mechanical stability.

17. The process as claimed in any one of claims 12 to 16, in which the (physico)chemical switch(es) is/are chosen to comprise one or more substances which, when there is a change in the pH in the wash liquor or cleaning liquor in the range from 11 to 6, preferably in the range from 10 to 7, more preferably a decrease in the pH in the range between 10 and 8,
(a) undergo a change in solubility in water; and/or
(b) undergo a change in diffusion density; and/or
(c) undergo a change in dissolution kinetics; and/or
(d) undergo a change in mechanical stability; preferably
(a) undergo an increase in solubility in water; and/or
(b) undergo a decrease in diffusion density; and/or
(c) undergo an acceleration in dissolution kinetics; and/or
(d) undergo a decrease in mechanical stability.

18. The process as claimed in any one of claims 12 to 17, in which the (physico)chemical switch(es) used comprise/comprises one or more substances from the group consisting of basic polymers and/or copolymers, preferably basic polymers and/or copolymers containing amino groups and/or aminoalkyl groups, imino groups and/or pyridine groups, more preferably still an aminoalkyl methacrylate copolymer.

19. A washing process, especially a washing process in a washing machine, in which a laundry detergent portion as claimed in any one of claims 1 to 11 is brought into contact with laundry, being inserted in particular into the detergent compartment of a commercially customary washing machine, and is rinsed into the wash liquor with water of the first wash cycle, the early steps of the wash operation are conducted as normal and then conditions are established under which the release controlling (physico)chemical switch(es), which is/are not subject or not subject exclusively to temperature control, releases/release into the wash liquor the component(s) intended for later release into the wash liquor.

20. A washing process, especially a washing process in a dishwashing machine, in which a dishwashing detergent portion as claimed in any one of claims 1 to 11 is brought into contact with ware, being inserted in particular into the detergent compartment of a commercially customary dishwashing machine, and is rinsed into the wash liquor with water of the first wash cycle, the early steps of the wash operation are conducted as normal and then conditions are established under which the release controlling (physico)chemical switch(es), which is/are not subject or not subject exclusively to temperature control, releases/release into the wash liquor the component(s) intended for later release into the wash liquor.

21. A cleaning process, in which a cleaning product detergent portion as claimed in any of claims 1 to 11 is brought into contact with material to be cleaned, the early steps of the cleaning operation are conducted as normal and then conditions are established under which the release controlling (physico)chemical switch(es), which is/are not subject or not subject exclusively to temperature control, releases/release into the cleaning liquor the component(s) intended for later release into the cleaning liquor.
